(19) United States
(12) Patent Application Publication
(10) Pub. No.: US 2025/0341225 A1
(43) Pub. Date: Nov. 6, 2025

(54) MONITORING USE OF A PNEUMATIC DEVICE

(71) Applicant: Unifiller Systems inc., Delta (CA)

(72) Inventors: Derek LANOVILLE, Delta, BC (CA); Vasyl BARYSHNIKOV, Delta, BC (CA); Rafal ORZECHOWSKI, Delta, BC (CA); Borys Mateusz CIESLAK, Delta, BC (CA); Mauricio NAHUM LEROY, Delta, BC (CA)

(73) Assignee: Unifiller Systems ULC, Delta, BC (CA)

(21) Appl. No.: 18/862,375

(22) PCT Filed: Sep. 28, 2022
(86) PCT No.: PCT/CA2022/051441

§ 371 Date: Nov. 1, 2024

Related U.S. Application Data
(60) Provisional application No. 63/338,305, filed on May 4, 2022.

(51) Int. Cl. F15B 19/00; G01F 1/66

(52) U.S. Cl. CPC F15B 19/00; G01F 1/662

(57) ABSTRACT

A system for monitoring use of a pneumatic device by one or more operators is disclosed. The system includes at least one processor configured to receive a representation of a sensed fluid signal produced by at least one sensor configured to sense fluid flow associated with the pneumatic device, identify a cyclical feature of the fluid flow based on the received representation of the sensed fluid signal, and increment a device cycle count for the pneumatic device in response to identifying the cyclical feature. Other systems, apparatuses, methods, and computer-readable media are disclosed.

### CROSS REFERENCES

This application claims the benefit of U.S. Provisional Application No. 63/338,305 entitled “MONITORING USE OF A PNEUMATIC DEVICE”, filed on May 4, 2022, which is hereby incorporated by reference herein in its entirety.

### BACKGROUND

### 1. Field

Embodiments of this disclosure relate to device monitoring and more particularly to monitoring use of a pneumatic device.

### 2. Description of Related Art

Pneumatic devices such as pneumatic actuators may deliver large mechanical power at high speed. Pneumatic devices may be inexpensive, easier to clean and maintain, and more durable compared to electronic counterparts that may deliver similar performance. However, it may be difficult to monitor use of pneumatic devices and/or to analyze such use to facilitate efficient maintenance and/or replacement of such devices.

### SUMMARY

In accordance with various embodiments, there is provided a system for monitoring use of a pneumatic device by one or more operators, the system including at least one processor configured to receive a representation of a sensed fluid signal produced by at least one sensor configured to sense fluid flow associated with the pneumatic device, identify a cyclical feature of the fluid flow based on the received representation of the sensed fluid signal, and increment a device cycle count for the pneumatic device in response to identifying the cyclical feature.

The system may include a sensed fluid signal filter configured to receive the sensed fluid signal from the at least one sensor, filter the sensed fluid signal to generate a filtered representation of the sensed fluid signal, and cause the filtered representation to be transmitted to the at least one processor, the at least one processor may be configured to receive the filtered representation and identify the cyclical feature based at least in part on the filtered representation.

The sensed fluid signal filter may include a low pass filter configured to filter high frequency components out of the sensed fluid signal.

The at least one processor may be configured to identify an edge of the filtered representation of the sensed fluid signal.

The at least one processor may be configured to compare the device cycle count with a threshold cycle count to determine whether the device cycle count is greater than the threshold cycle count, and, in response to determining that the device cycle count is greater than the threshold cycle count, produce signals for causing a service notification to be displayed to at least one of the one or more operators.

The at least one processor may be configured to receive a pneumatic device identifier identifying the pneumatic device and determine the threshold cycle count based at least in part on the pneumatic device identifier.

The at least one processor may be configured to identify service order information associated with the threshold cycle count and to include the service order information in the service notification.

The service order information may include replacement ordering information.

The at least one processor may be configured to determine a remaining cycle count, the remaining cycle count being a difference between a milestone cycle count and the device cycle count.

The milestone cycle count may include a predicted end of life cycle count.

The at least one processor may be configured to produce signals for causing a representation of the remaining cycle count to be displayed to at least one of the one or more operators.

The at least one processor may be configured to receive a pneumatic device identifier identifying the pneumatic device and determine the milestone cycle count based at least in part on the pneumatic device identifier.

The at least one processor may be configured to determine a predicted cycling rate, the predicted cycling rate representing a predicted number of cycles that the pneumatic device will be used for during a future time period, determine a device action date based at least in part on the predicted cycling rate and the remaining cycle count, and produce signals for causing a representation of the device action date to be displayed to at least one of the one or more operators.

The milestone cycle count may include a suggested service cycle count and the device action date may include a suggested device service date.

The at least one processor may be configured to produce signals for causing a calendar depicting the suggested service date to be displayed.

The at least one processor may be configured to receive a plurality of candidate service dates on which service of the pneumatic device is preferred and the at least one processor may be configured to determine an ideal service date based at least in part on the predicted cycling rate and the remaining cycle count and select the suggested service date from the plurality of candidate service dates based at least in part on proximity to the ideal service date.

The at least one processor may be configured to receive a representation of device cycle counts over time and determine the predicted cycling rate based on the device cycle counts over time.

The at least one processor may be configured to determine an exponential moving average of the device cycle counts over time and determine the predicted cycling rate using the exponential moving average.

The at least one processor may be configured to apply a trend identifying filter to the device cycle counts over time to determine the predicted cycling rate.

The at least one processor may be configured to apply a low pass filter to the device cycle counts over time to determine an average rate of change of the device cycle counts over a past time period and determine the predicted cycling rate to be equal to the determined average rate of change.

The at least one processor may include at least one counter processor and at least one analyzer processor, the at least one counter processor configured to produce signals for causing a representation of the device cycle count to be transmitted to an analyzer including the at least one analyzer processor, the analyzer being separately powered from the at least one counter processor, and the at least one analyzer processor may be configured to receive the representation of the device cycle count.

The at least one counter processor may be configured to determine a waiting time duration since a most recent cycle performance by the pneumatic device, compare the waiting time duration since the most recent cycle performance with a threshold time duration to determine whether the waiting time duration is greater than the threshold time duration, and if the waiting time duration is less than the threshold time duration, produce wireless signals requesting a wireless connection for sending the representation of the device cycle count to the analyzer.

The threshold time duration may be greater than 5 seconds.

The threshold time duration may be greater than 10 minutes.

The threshold time duration may be less than 120 minutes.

The at least one processor may be configured to receive a facility size representing a size of a facility within which the pneumatic device is operating and cause the at least one counter processor to produce wireless signals requesting a wireless connection for sending the representation of the device cycle count to the analyzer, the wireless signals based at least in part on the facility size.

The facility size may be associated with a signal power and the at least one processor may be configured to cause the at least one counter processor to produce the wireless signals having power set to the associated signal power.

The facility size may be associated with a signal repeating interval and the at least one processor may be configured to cause the at least one counter processor to repeatedly produce wireless signals at intervals set to the associated signal repeating interval.

The device cycle count may include a first device cycle count and the at least one processor may include at least one aggregator processor configured to determine whether a time elapsed since receiving the representation of the first device cycle count is greater than a threshold time elapsed, and, if the time elapsed is greater than the threshold time elapsed, request a second representation of a second device cycle count for the pneumatic device.

The threshold time elapsed may be greater than 10 minutes.

The system may include the pneumatic device.

The fluid flow associated with the pneumatic device may include exhaust gas flow from the pneumatic device.

The system may include the at least one sensor configured to sense the fluid flow associated with the pneumatic device and to produce the sensed fluid signal.

The system may include a fluid collector having an inlet configured to receive the fluid flow from the pneumatic device, a passage coupled to the inlet, and an outlet coupled to the passage and configured to output the fluid flow, wherein the at least one sensor is configured to sense the fluid flow in the passage of the fluid collector.

The fluid collector may include at least one fluid redirecting surface in the passage configured to cause a change in direction of the fluid flow and the at least one sensor may be configured to sense forces on the at least one fluid redirecting surface.

The at least one fluid redirecting surface may be configured to cause at least about a 90 degree change in direction of the fluid flow.

The passage may include an input portion, an output portion, and a sensing portion coupled between the input portion and the output portion, wherein the input and output portions are generally parallel and configured to facilitate movement of the fluid flow in opposite directions, and wherein the sensing portion includes the at least one fluid redirecting surface.

The at least one sensor may include at least one piezo crystal transducer.

The at least one sensor may include a sensor mount and the piezo crystal transducer may be held at a first end portion by the sensor mount, such that a second end portion of the piezo crystal transducer opposite the first end portion is suspended in the passage.

The at least one processor may be configured to receive a partial device cycle count representing a count of cycles performed by the pneumatic device over a counted operating time period, receive a representation of a duration of an uncounted operating time period, determine an estimated cycle count over the uncounted time period based at least in part on the partial device cycle count, a duration of the counted operating time period, and the duration of the uncounted operating time period, and determine the device cycle count based at least in part on the estimated cycle count over the uncounted time period.

The at least one processor may be configured to sum the estimated cycle count over the uncounted time period with the partial device cycle count.

The partial device cycle count may be a first partial device cycle count and the counted operating time period may be a first counted operating time period, and the at least one processor may be configured to receive a second partial device cycle count and sum the estimated cycle count over the uncounted time period with the second partial device cycle count.

The at least one processor may be configured to determine an estimated cycling rate during the uncounted operating time period, and multiply the estimated cycling rate by the duration of the uncounted operating time period.

The at least one processor may be configured to determine a ratio between the partial device cycle count and a duration of the counted operating time period.

In accordance with various embodiments, there is provided a method of monitoring use of a pneumatic device by one or more operators, the method including receiving a representation of a sensed fluid signal produced by at least one sensor configured to sense fluid flow associated with the pneumatic device, identifying a cyclical feature of the fluid flow based on the received sensed fluid signals, and incrementing a device cycle count for the pneumatic device in response to identifying the cyclical feature.

The method may include receiving the sensed fluid signal from the at least one sensor, and filtering the sensed fluid signal to generate a filtered representation of the sensed fluid signal, wherein identifying the cyclical feature of the fluid flow based on the received sensed fluid signals includes identifying the cyclical feature based at least in part on the filtered representation.

Identifying the cyclical feature of the fluid flow based on the received sensed fluid signals may include identifying an edge of the filtered representation of the sensed fluid signal.

The method may include comparing the device cycle count with a threshold cycle count to determine whether the device cycle count is greater than the threshold cycle count, and in response to determining that the device cycle count is greater than the threshold cycle count, producing signals for causing a service notification to be displayed to at least one of the one or more operators.

The method may include receiving a pneumatic device identifier identifying the pneumatic device and determining the threshold cycle count based at least in part on the pneumatic device identifier.

The method may include identifying service order information associated with the threshold cycle count and including the service order information in the service notification.

The service order information may include replacement pneumatic device ordering information and including the service order information in the service notification may involve including the replacement ordering information in the service notification.

The method may include determining a remaining cycle count, the remaining cycle count being a difference between a milestone cycle count and the device cycle count.

The milestone cycle count may include a predicted end of life cycle count.

The method may include producing signals for causing a representation of the remaining cycle count to be displayed to at least one of the one or more operators.

The method may include receiving a pneumatic device identifier identifying the pneumatic device and determining the milestone cycle count based at least in part on the pneumatic device identifier.

The method may include determining a predicted cycling rate, the predicted cycling rate representing a predicted number of cycles that the pneumatic device will be used for during a future time period, determining a device action date based at least in part on the predicted cycling rate and the remaining cycle count, and producing signals for causing a representation of the device action date to be displayed to at least one of the one or more operators.

The milestone cycle count may include a suggested service cycle count and the device action date may include a suggested device service date.

Producing the signals for causing the representation of the device action date to be displayed may include producing signals for causing a calendar depicting the suggested service date to be displayed.

The method may include receiving a plurality of candidate service dates on which service of the pneumatic device is preferred and determining the device action date may include determining an ideal service date based at least in part on the predicted cycling rate and the remaining cycle count and selecting the suggested service date from the plurality of candidate service dates based at least in part on proximity to the ideal service date.

Determining the predicted cycling rate may include receiving representations of device cycle counts over time and determining the predicted cycling rate based on the device cycle counts over time.

Determining the predicted cycling rate may include determining an exponential moving average of the device cycle counts over time and determining the predicted cycling rate using the exponential moving average.

Determining the predicted cycling rate may include applying a trend identifying filter to the device cycle counts over time to determine the predicted cycling rate.

Determining the predicted cycling rate may include applying a low pass filter to the device cycle counts over time to determine an average rate of change of the device cycle counts over a past time period and determining the predicted cycling rate to be equal to the determined average rate of change.

The method may include producing signals for causing a representation of the device cycle count to be transmitted by a counter to an analyzer separately powered from the counter and receiving the representation of the device cycle count by the analyzer.

The method may include determining a waiting time duration since a most recent cycle performance by the pneumatic device, comparing the waiting time duration since the most recent cycle performance with a threshold time duration to determine whether the waiting time duration is greater than the threshold time duration, and, if the waiting time duration is less than the threshold time duration, producing wireless signals requesting a wireless connection for sending the representation of the device cycle count to the analyzer.

The threshold time duration may be greater than 5 seconds.

The threshold time duration may be greater than 10 minutes.

The threshold time duration may be less than 120 minutes.

The method may include receiving a facility size representing a size of a facility within which the pneumatic device is operating, and causing the counter to produce wireless signals requesting a wireless connection for sending the representation of the device cycle count to the analyzer, the wireless signals based at least in part on the facility size.

The facility size may be associated with a signal power and causing the counter to produce the wireless signals requesting the wireless connection may include causing the counter to produce the wireless signals having power set to the associated signal power.

The facility size may be associated with a signal repeating interval and causing the counter to produce the wireless signals requesting the wireless connection may include causing the counter to repeatedly produce wireless signals at intervals set to the associated signal repeating interval.

The device cycle count may include a first device cycle count and the method may include determining whether a time elapsed since receiving the representation of the first device cycle count is greater than a threshold time elapsed, and, if the time elapsed is greater than the threshold time elapsed, requesting a second representation of a second device cycle count for the pneumatic device.

The threshold time elapsed may be greater than 10 minutes.

The method may include controlling the pneumatic device.

The fluid flow associated with the pneumatic device may include exhaust gas flow from the pneumatic device.

The method may include sensing the fluid flow associated with the pneumatic device and producing the sensed fluid signal.

The method may include receiving the fluid flow via an inlet of a fluid collector, causing the fluid flow to flow through a passage of the fluid collector coupled to the inlet and through an outlet coupled to the passage to output the fluid flow, wherein sensing the fluid flow associated with the pneumatic device includes sensing the fluid flow in the passage of the fluid collector.

The method may include causing at least one fluid redirecting surface to redirect the fluid flow in the passage to cause a change in direction of the fluid flow, wherein sensing the fluid flow associated with the pneumatic device includes sensing forces on the at least one fluid redirecting surface.

Causing the at least one fluid redirecting surface of the passage to redirect the fluid flow may include causing the at least one fluid redirecting surface of the passage to redirect the fluid flow to cause at least about a 90 degree change in direction of the fluid flow.

Causing the fluid flow to flow through the passage of the fluid collector may include causing the fluid flow to flow through an input portion of the passage, a sensing portion of the passage coupled to the input portion of the passage, and an output portion of the passage coupled to the sensing portion of the passage, wherein causing the fluid flow to flow through the input portion of the passage and the output portion of the passage includes causing the fluid flow to flow in opposite parallel directions, and wherein sensing the forces on the at least one fluid redirecting surface includes sensing the forces in the sensing portion of the passage.

Sensing the fluid flow associated with the pneumatic device may include sensing the fluid flow using at least one piezo crystal transducer.

Sensing the fluid flow using the eat least one piezo crystal plate transducer may include holding the piezo crystal transducer at a first end portion by a sensor mount, such that a second end portion of the piezo crystal transducer opposite the first end portion is suspended in the passage.

In accordance with various embodiments, there is provided a method of monitoring use of a pneumatic device by one or more operators, the method including receiving a pneumatic device identifier identifying the pneumatic device, receiving a representation of a device cycle count for the pneumatic device, determining a threshold cycle count based at least in part on the pneumatic device identifier, comparing the device cycle count with the threshold cycle count to determine whether the device cycle count is greater than the threshold cycle count, and, in response to determining that the device cycle count is greater than the threshold cycle count, producing signals for causing a service notification to be displayed to at least one of the one or more operators.

The device cycle count may include a first device cycle count, the method including determining whether a time elapsed since receiving the representation of the first device cycle count time is greater than a threshold time elapsed, and if the time elapsed is greater than the threshold time elapsed, requesting a second representation of a second device cycle count for the pneumatic device.

The threshold time elapsed may be greater than 10 minutes.

The method may include identifying service order information associated with the threshold cycle count and including the service order information in the service notification.

The service order information may include replacement pneumatic device ordering information and including the service order information in the service notification may include including the replacement pneumatic device ordering information in the service notification.

The method may include determining a remaining cycle count, the remaining cycle count being a difference between a milestone cycle count and the device cycle count.

The milestone cycle count may include a predicted end of life cycle count.

The method may include producing signals for causing a representation of the remaining cycle count to be displayed to at least one of the one or more operators.

The method may include determining the milestone cycle count based at least in part on the pneumatic device identifier.

The method may include determining a predicted cycling rate, the predicted cycling rate representing a predicted number of cycles that the pneumatic device will be used for during a future time period, determining a device action date based at least in part on the predicted cycling rate and the remaining cycle count, and producing signals for causing a representation of the device action date to be displayed to at least one of the one or more operators.

The milestone cycle count may include a suggested service cycle count and the device action date may include a suggested device service date.

Producing the signals for causing the representation of the device action date to be displayed may include producing signals for causing a calendar depicting the suggested service date to be displayed.

The method may include receiving a plurality of candidate service dates on which service of the pneumatic device is preferred and determining the device action date may include determining an ideal service date based at least in part on the predicted cycling rate and the remaining cycle count and selecting the suggested service date from the plurality of candidate service dates based at least in part on proximity to the ideal service date.

Determining the predicted cycling rate may include receiving representations of device cycle counts over time and determining the predicted cycling rate based on the device cycle counts over time.

Determining the predicted cycling rate may include determining an exponential moving average of the device cycle counts over time and determining the predicted cycling rate using the exponential moving average.

Determining the predicted cycling rate may include applying a trend identifying filter to the device cycle counts over time to determine the predicted cycling rate.

Determining the predicted cycling rate may include applying a low pass filter to the device cycle counts over time to determine an average rate of change of the device cycle counts over a past time period and determining the predicted cycling rate to be equal to the determined average rate of change.

In accordance with various embodiments, there is provided a method of monitoring use of a pneumatic device by one or more operators, the method including receiving a representation of a device cycle count for the pneumatic device, and determining a remaining cycle count, the remaining cycle count being a difference between a milestone cycle count and the device cycle count.

The milestone cycle count may include a predicted end of life cycle count.

The method may include producing signals for causing a representation of the remaining cycle count to be displayed to at least one of the one or more operators.

The method may include receiving a pneumatic device identifier identifying the pneumatic device and determining the milestone cycle count based at least in part on the pneumatic device identifier.

The method may include determining a predicted cycling rate, the predicted cycling rate representing a predicted number of cycles that the pneumatic device will be used for during a future time period, determining a device action date based at least in part on the predicted cycling rate and the remaining cycle count, and producing signals for causing a representation of the device action date to be displayed to at least one of the one or more operators.

The milestone cycle count may include a suggested service cycle count and the device action date may include a suggested device service date.

Producing the signals for causing the representation of the device action date to be displayed may include producing signals for causing a calendar depicting the suggested service date to be displayed.

The method may include receiving a plurality of candidate service dates on which service of the pneumatic device is preferred and determining the device action date may include determining an ideal service date based at least in part on the predicted cycling rate and the remaining cycle count and selecting the suggested service date from the plurality of candidate service dates based at least in part on proximity to the ideal service date.

Determining the predicted cycling rate may include receiving representations of device cycle counts over time and determining the predicted cycling rate based on the device cycle counts over time.

Determining the predicted cycling rate may include determining an exponential moving average of the device cycle counts over time and determining the predicted cycling rate using the exponential moving average.

Determining the predicted cycling rate may include applying a trend identifying filter to the device cycle counts over time to determine the predicted cycling rate.

Determining the predicted cycling rate may include applying a low pass filter to the device cycle counts over time to determine an average rate of change of the device cycle counts over a past time period and determining the predicted cycling rate to be equal to the determined average rate of change.

The method may include receiving a partial device cycle count representing a count of cycles performed by the pneumatic device over a counted operating time period, receiving a representation of a duration of an uncounted operating time period, determining an estimated cycle count over the uncounted time period based at least in part on the partial device cycle count, a duration of the counted operating time period, and the duration of the uncounted operating time period, and determining the device cycle count based at least in part on the estimated cycle count over the uncounted time period.

Determining the device cycle count may include summing the estimated cycle count over the uncounted time period with the partial device cycle count.

The partial device cycle count may be a first partial device cycle count and the counted operating time period may be a first counted operating time period, and determining the device cycle count may include receiving a second partial device cycle count and summing the estimated cycle count over the uncounted time period with the second partial device cycle count.

Determining the estimated cycle count over the uncounted time period may include determining an estimated cycling rate during the uncounted operating time period, and multiplying the estimated cycling rate by the duration of the uncounted operating time period.

Determining the estimated cycling rate during the uncounted operating time period may include determining a ratio between the partial device cycle count and a duration of the counted operating time period.

The method may include comparing the device cycle count with a threshold cycle count to determine whether the device cycle count is greater than the threshold cycle count, and, in response to determining that the device cycle count is greater than the threshold cycle count, producing signals for causing a service notification to be displayed to at least one of the one or more operators.

In accordance with various embodiments, there is provided a method of monitoring use of a pneumatic device by one or more operators, the method including receiving a partial device cycle count representing a count of cycles performed by the pneumatic device over a counted operating time period, receiving a representation of a duration of an uncounted operating time period, determining an estimated cycle count over the uncounted time period based at least in part on the partial device cycle count, a duration of the counted operating time period, and the duration of the uncounted operating time period, and determining a device cycle count based at least in part on the estimated cycle count over the uncounted time period.

Determining the device cycle count may include summing the estimated cycle count over the uncounted time period with the partial device cycle count.

The partial device cycle count may be a first device cycle count and the counted operating time period may be a first counted operating time period, wherein determining the device cycle count includes summing the estimated cycle count over the uncounted time period with the second partial device cycle count.

Determining the estimated cycle count over the uncounted time period may include determining an estimated cycling rate during the uncounted operating time period, and multiplying the estimated cycling rate by the duration of the uncounted operating time period.

Determining the estimated cycling rate during the uncounted operating time period may include determining a ratio between the partial device cycle count and a duration of the counted operating time period.

The method may include comparing the device cycle count with a threshold cycle count to determine whether the device cycle count is greater than the threshold cycle count, and, in response to determining that the device cycle count is greater than the threshold cycle count, producing signals for causing a service notification to be displayed to at least one of the one or more operators.

In accordance with various embodiments, there is provided a method of monitoring use of a pneumatic device by one or more operators, the method including determining a waiting time duration since a most recent cycle performance by the pneumatic device, comparing the waiting time duration since the most recent cycle performance with a threshold time duration to determine whether the waiting time duration is greater than the threshold time duration, and, if the waiting time duration is less than the threshold time duration, producing signals requesting a wireless connection for sending a representation of a device cycle count for the pneumatic device to an analyzer.

The threshold time duration may be greater than 5 seconds.

The threshold time duration may be greater than 10 minutes.

The threshold time duration may be less than 120 minutes.

The method may include receiving a facility size representing a size of a facility within which the pneumatic device is operating, and producing wireless signals requesting the wireless connection based at least in part on the facility size.

The facility size may be associated with a signal power and producing the wireless signals requesting the wireless connection may include producing the wireless signals having power set to the associated signal power.

The facility size may be associated with a signal repeating interval and producing the wireless signals requesting the wireless connection may include repeatedly producing wireless signals at intervals set to the associated signal repeating interval.

In accordance with various embodiments, there is provided a method of monitoring use of a pneumatic device by one or more operators, the method including receiving a facility size representing a size of a facility within which the pneumatic device is operating, and causing wireless signals to be produced based at least in part on the facility size, the wireless signals requesting a wireless connection for sending a representation of a device cycle count for the pneumatic device to an analyzer.

The facility size may be associated with a signal power and causing the wireless signals to be produced may include causing the wireless signals to have power set to the associated signal power.

The facility size may be associated with a signal repeating interval and causing the wireless signals to be produced may include causing the wireless signals to be produced repeatedly at intervals set to the associated signal repeating interval.

In accordance with various embodiments, there is provided a system for monitoring use of a pneumatic device, the system including at least one processor configured to perform any of the above methods.

In accordance with various embodiments, there is provided a non-transitory computer readable medium having stored thereon codes which when executed by at least one processor cause the at least one processor to perform any of the above methods.

Other aspects and features of embodiments of the disclosure will become apparent to those ordinarily skilled in the art upon review of the following description of specific embodiments of the disclosure in conjunction with the accompanying figures.

### BRIEF DESCRIPTION OF THE DRAWINGS

In drawings which illustrate embodiments of the disclosure,

FIG. 1 is a first schematic representation of a system for monitoring use of a pneumatic device, according to various embodiments;

FIG. 2 is a second schematic representation of the system shown in FIG. 1;

FIG. 3 is an enlarged view of a counter in the system shown in FIG. 1, in accordance with various embodiments;

FIG. 4 is a partial cross-sectional view of the counter shown in FIG. 3, in accordance with various embodiments;

FIG. 5 is a schematic view of the counter of the system shown in FIG. 1, including a processor circuit, in accordance with various embodiments;

FIG. 6 is a graph depicting a sensed fluid signal and a filtered representation thereof used in the system shown in FIG. 1, in accordance with various embodiments;

FIG. 7 is a schematic diagram of a sensed fluid signal filter of the system shown in FIG. 1, in accordance with various embodiments;

FIG. 8 is a flowchart depicting blocks of code for directing the counter shown in FIG. 5 to perform pneumatic device cycle counting functions, in accordance with various embodiments;

FIG. 9 is a flowchart depicting blocks of code for directing the counter shown in FIG. 5 to perform pneumatic device cycle count communication functions, in accordance with various embodiments;

FIG. 10 is a schematic view of an aggregator of the system shown in FIG. 1, including a processor circuit, in accordance with various embodiments;

FIG. 11 is a flowchart depicting blocks of code for directing the aggregator shown in FIG. 10 to perform pneumatic device use data aggregating functions, in accordance with various embodiments;

FIG. 12 is a representation of a counter device cycle count message that may be used in the system shown in FIG. 1, in accordance with various embodiments;

FIG. 13 is a representation of an aggregator device cycle count message that may be used in the system shown in FIG. 1, in accordance with various embodiments;

FIG. 14 is a schematic view of an analyzer of the system shown in FIG. 1, including a processor circuit, in accordance with various embodiments;

FIG. 15 is a flowchart depicting blocks of code for directing the analyzer shown in FIG. 14 to perform pneumatic device use monitoring functions, in accordance with various embodiments;

FIG. 16 is a representation of a device cycle count record that may be used in the system shown in FIG. 1, in accordance with various embodiments;

FIG. 17 is a representation of a pneumatic device threshold record that may be used in the system shown in FIG. 1, in accordance with various embodiments;

FIG. 18 is a representation of a subject threshold cycle count record that may be used in the system shown in FIG. 1, in accordance with various embodiments;

FIG. 19 is a representation of an aggregator device cycle count message that may be used in the system shown in FIG. 1, in accordance with various embodiments;

FIG. 20 is a representation of a pneumatic device service message record that may be used in the system shown in FIG. 1, in accordance with various embodiments;

FIG. 21 is a flowchart depicting blocks of code for directing the analyzer shown in FIG. 14 to perform pneumatic device use monitoring functions, in accordance with various embodiments;

FIG. 22 is a representation of an aggregator device cycle count message that may be used in the system shown in FIG. 1, in accordance with various embodiments;

FIG. 23 is a representation of a pneumatic device threshold record that may be used in the system shown in FIG. 1, in accordance with various embodiments;

FIG. 24 is a representation of a subject milestone cycle count record that may be used in the system shown in FIG. 1, in accordance with various embodiments;

FIG. 25 is a representation of a remaining cycle count record that may be used in the system shown in FIG. 1, in accordance with various embodiments;

FIG. 26 is a representation of a predicted cycling rate record that may be used in the system shown in FIG. 1, in accordance with various embodiments;

FIG. 27 is a representation of a candidate service date record that may be used in the system shown in FIG. 1, in accordance with various embodiments;

FIG. 28 is a representation of a device action date record that may be used in the system shown in FIG. 1, in accordance with various embodiments;

FIG. 29 is a representation of a display that may be provided in the system shown in FIG. 1, in accordance with various embodiments;

FIG. 30 is a flowchart depicting blocks of code for directing the analyzer shown in FIG. 14 to perform pneumatic device use monitoring functions, in accordance with various embodiments;

FIG. 31 is a schematic representation of a system for monitoring use of a pneumatic device, according to various embodiments;

FIG. 32 is a schematic view of an analyzer of the system shown in FIG. 31, including a processor circuit, in accordance with various embodiments;

FIG. 33 is a flowchart depicting blocks of code for directing the analyzer shown in FIG. 32 to perform pneumatic device use monitoring functions, in accordance with various embodiments;

FIG. 34 is a representation of an aggregator device cycle count message that may be used in the system shown in FIG. 31, in accordance with various embodiments;

FIG. 35 is a representation of an aggregator device cycle count message that may be used in the system shown in FIG. 31, in accordance with various embodiments;

FIG. 36 is a representation of an uncounted time period message that may be used in the system shown in FIG. 31, in accordance with various embodiments;

FIG. 37 is a representation of an uncounted cycle count record that may be used in the system shown in FIG. 31, in accordance with various embodiments;

FIG. 38 is a representation of an aggregate device cycle count record that may be used in the system shown in FIG. 31, in accordance with various embodiments;

FIG. 39 is a schematic representation of a system for monitoring use of pneumatic devices, according to various embodiments;

FIG. 40 is a representation of a facility size message that may be used in the system shown in FIG. 31, in accordance with various embodiments;

FIG. 41 is a flowchart depicting blocks of code for directing the analyzer shown in FIG. 14 to perform pneumatic device use monitoring set up functions, in accordance with various embodiments;

FIG. 42 is a representation of a facility size signal properties record that may be used in the system shown in FIG. 1, in accordance with various embodiments;

FIG. 43 is a representation of a signal properties message that may be used in the system shown in FIG. 1, in accordance with various embodiments;

FIG. 44 is a schematic diagram of a sensed fluid signal filter that may be used in a system generally similar to the system shown in FIG. 1, in accordance with various embodiments;

FIG. 45 is a side view of a counter that may be used in a system generally similar to the system shown in FIG. 1, in accordance with various embodiments;

FIG. 46 is a top view of the counter shown in FIG. 45, in accordance with various embodiments;

FIG. 47 is a cross sectional side view of the counter shown in FIG. 45, in accordance with various embodiments; and

FIG. 48 is a perspective view of the counter shown in FIG. 45 with a cover removed, in accordance with various embodiments.

### DETAILED DESCRIPTION

Pneumatic systems or machines may be able to provide high mechanical power at high speed. These devices may be inexpensive, easier to clean and maintain, and/or more durable compared to electronic counterparts that may deliver similar performance. Thus, pneumatic devices may be well suited for various systems or applications, such as, for food industry systems including, for example, automated bakery equipment, cake and cupcake decorating equipment, single and multi-piston depositors, food pumps, filling machines, icing machines, pastry machines, cookie machines, and/or other food preparation systems.

Pneumatic devices and systems may include components that need regular servicing and/or replacement, such as cylinders that have a predetermined or predicted number of cycles they can withstand before maintenance is suggested or failure is predicted. In some embodiments, monitoring use of a pneumatic device may facilitate identification or prediction of a required service or failure point of a pneumatic component. In some embodiments, for example, knowing how many cycles a pneumatic device has completed may facilitate prediction of when service should be required or failure is expected to occur, since future suggested service dates and/or failure of the pneumatic device may depend in large part on the number of cycles the pneumatic device has completed.

In various embodiments, prediction of the timing of a current or future wear level or failure may enable an operator of a pneumatic device to provide timely service and/or replacement of the pneumatic device at or before reduced effectiveness or failure. In various embodiments, this may improve system efficiency, reduce downtime of the pneumatic device or system, and/or reduce costs associated with the service and/or replacement. In various embodiments, this may result in reduced costs and/or increased profitability associated with the pneumatic device and/or system.

In various embodiments, such monitoring may be facilitated by keeping the use of power low, which may enable battery operation of at least some components of the system and/or ease of installation and maintenance.

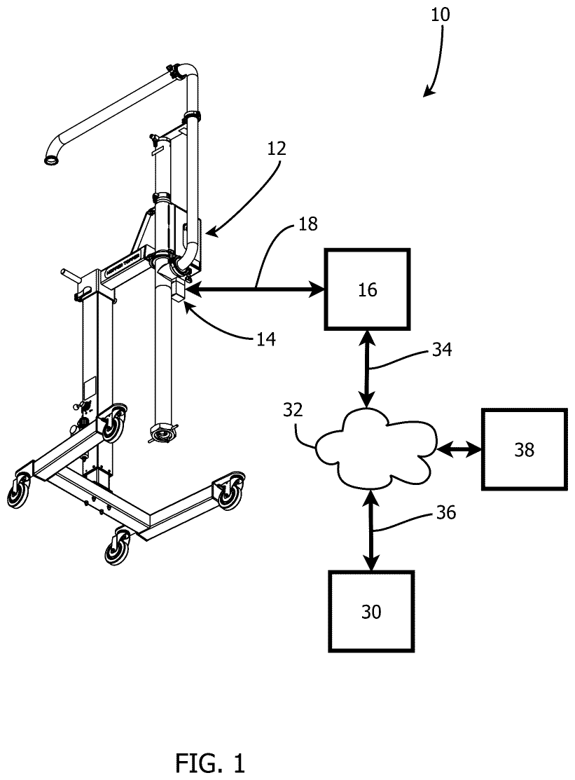

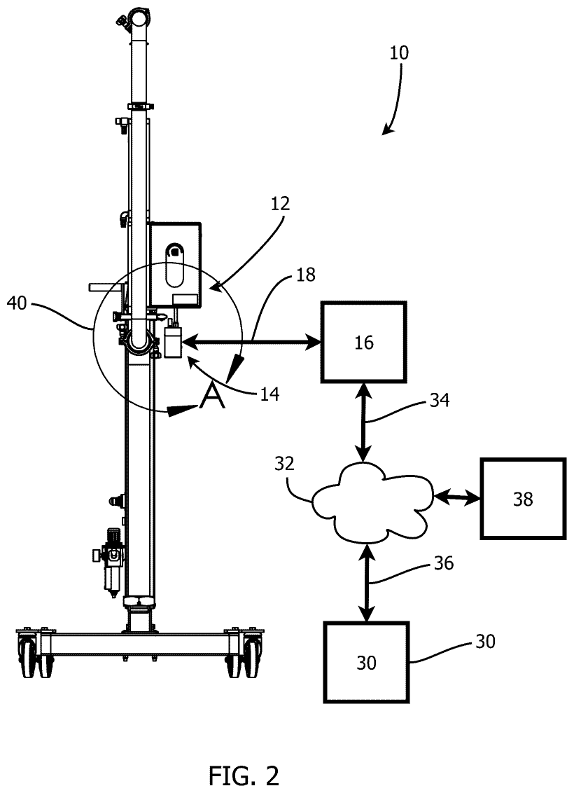

Referring now to FIGS. 1 and 2, there are shown schematic representations, from a lower perspective and a front view respectively, of a system 10 for monitoring use of a pneumatic device 12, in accordance with various embodiments. In the exemplary embodiment shown in FIGS. 1 and 2, the pneumatic device 12 includes a pneumatic powered pump used by one or more operators in the food industry, such as for moving or transferring food product in a food assembly line, for example. In some embodiments, the pneumatic device 12 may be controlled using gas pressure and flow. In some embodiments, the pneumatic device 12 may function by moving the food in discrete pump cycles, at a rate of about 10-60 cycles per minute, for example. In various embodiments, alternative and/or additional pneumatic devices may be included in the system 10 or a system generally similar to the system 10 and monitored generally as described herein.

Referring to FIG. 1, in various embodiments, the system 10 includes a counter 14 configured to count cycles of the pneumatic device 12. In various embodiments, the counter 14 may include a sensor configured to sense fluid flow associated with the pneumatic device 12. For example, in some embodiments, the sensor may be configured to sense fluid flow from exhaust gas expelled by the pneumatic device 12 during use. In various embodiments, the counter 14 may be configured to receive a representation of a sensed fluid signal produced by the sensor. In various embodiments, sensing fluid flow from exhaust gas may facilitate the counter 14 being useable with various pneumatic devices without requiring the counter 14 to be integrated with or specially designed for each pneumatic device.

The counter 14 may be configured to identify a cyclical feature of the fluid flow based on the received representation of the sensed fluid signal. For example, in some embodiments, the cyclical feature may be a feature that is identifiable once per use cycle of the pneumatic device 12. In various embodiments, a use cycle of the pneumatic device 12 may be a discrete repeated process that the pneumatic device 12 performs during use. For example, in some embodiments, a use cycle may involve opening and closing of a valve and the cyclical feature may be identifiable only once during the use cycle, such that identifying the cyclical feature and counting occurrences of the cyclical feature may equate to identifying and counting occurrences of the use cycle of the pneumatic device 12.

In some embodiments, the cyclical feature may be an initial blast of fluid flow provided by an exhaust of the pneumatic device 12. In some embodiments, identifying the cyclical feature may involve identifying an edge or a digital edge in a filtered representation of the sensed fluid signal. In various embodiments, an edge may be identified when voltage from the filtered representation of the sensed fluid signal changes from a high logic state to a low logic state or from a low logic state to a high logic state, for example. In some embodiments, the edge may be indicative of exhaust being expelled by the pneumatic device 12. In some embodiments, the edge may be indicative of a cyclical feature because it may be identifiable only once per use cycle of the pneumatic device 12. In some embodiments, detecting the edge of the filtered signal may facilitate registering or counting the cycle quickly, without waiting for too long. In various embodiments, a new fresh edge may represent an end of the cycle. For example, the air may be blowing for 2 seconds, but there will only be one edge indicating the air started to blow. In various embodiments, employing edge detection may facilitate use of microcontroller inputs, which may be edge driven.

Referring still to FIGS. 1 and 2, in various embodiments, the counter 14 may be configured to increment a device cycle count for the pneumatic device 12 in response to identifying the cyclical feature. For example, in various embodiments, the counter 14 may be configured to store a device cycle count in memory and increment the count whenever the cyclical feature is identified. In various embodiments, the device cycle count may be initialized to a starting value (such as 0, for example, in some embodiments, when the pneumatic device 12 is first installed) and it may be incremented each time the counter 14 identifies the cyclical feature. Accordingly, in various embodiments, the device cycle count stored in memory may represent a total number of cycles for which the pneumatic device has been used since installation of the counter. In some embodiments, the counter 14 may have been installed at the beginning of the lifetime of the pneumatic device and the device cycle count may represent a total number of cycles for which the pneumatic device has been used in its working lifetime.

Referring still to FIGS. 1 and 2, in some embodiments, the system 10 may include an aggregator 16 in communication with the counter 14 via a communication link 18. In some embodiments, the aggregator 16 may include a computing device configured to communicate with the counter 14. In some embodiments, the aggregator 16 may include, for example, a mobile device, a mobile phone, a tablet, a stationary computer, or another computing device configured to communicate with the counter 14. In some embodiments, the communication link 18 may be a wireless communication link, such as a Bluetooth™ connection, for example.

Referring still to FIGS. 1 and 2, the system 10 may include an analyzer 30 in communication with the aggregator 16 via a network 32 and communication links 34 and 36. In some embodiments, for example, the analyzer 30 may include a server computing device or a system of networked server computing devices. In various embodiments, the network 32 may be the Internet, the communication link 34 may include a wireless communication link, such as a wireless broadband communication connection, and the communication link 36 may be a wired connection. In various embodiments, other communication links may be used. In some embodiments, the system 10 may also include an operator device 38 in communication with the analyzer 30. In some embodiments, for example, the operator device 38 may include a device that is configured to connect to the Internet, such as, for example, a mobile device or personal computer.

In various embodiments, the counter 14 may be configured to produce signals for causing a representation of the device cycle count to be transmitted to the analyzer 30. In various embodiments, the analyzer 30 may be separately powered from the counter 14. In various embodiments, this may facilitate analysis being done by the analyzer instead of the counter 14, which may reduce power consumption by the counter 14. In some embodiments, this reduced power consumption may facilitate the counter 14 being run wirelessly and/or under battery power only, which may facilitate ease of installation and maintenance of the counter 14.

The analyzer 30 may be configured to receive the representation of the device cycle count. In some embodiments, the counter 14 may transmit the device cycle count to the aggregator 16 and the aggregator 16 may receive and then transmit the device cycle count to the analyzer 30 via the communication links 34 and 36 and the network 32. In some embodiments, the counter 14 may also transmit a pneumatic device identifier to the aggregator 16, the pneumatic device identifier having been previously provided and which may uniquely identify the pneumatic device 12. The aggregator 16 may receive and then transmit the pneumatic device identifier to the analyzer 30 via the communication links 34 and 36 and the network 32. In various embodiments, associating the pneumatic device identifier with the device cycle count may facilitate use of the aggregator 16, analyzer 30, and/or operator device 38 with different types of pneumatic devices and/or more than one pneumatic device at once. In various embodiments, this may facilitate reduced manufacturing and installation costs for the system 10 in a variety of pneumatic applications.

In some embodiments, configuration of the communication link 34 and/or transmission of the device cycle count from the counter 14 to the aggregator 16 may facilitate accurate monitoring of the device cycle count while keeping power consumption by the counter 14 and/or aggregator 16 low.

Referring still to FIGS. 1 and 2, in various embodiments, the analyzer 30 may be configured to analyze the device cycle count and to take action based on the analysis. For example, in some embodiments, the analyzer 30 may be configured to compare the device cycle count with a threshold cycle count to determine whether the device cycle count is greater than the threshold cycle count. In some embodiments, the analyzer 30 may be configured to determine the threshold cycle count based at least in part on the pneumatic device identifier. In some embodiments, the analyzer 30 may be configured to look up the threshold cycle count using the pneumatic device identifier, the threshold cycle count having been previously determined and/or received by the analyzer 30. In some embodiments, various threshold cycle counts may be applied, each associated with a different alert or action to be taken.

For example, in various embodiments, the device cycle count exceeding the threshold cycle count may indicate that the pneumatic device 12 is nearing an expected failure or that a service or maintenance of the pneumatic device is suggested. In various embodiments, the analyzer 30 may be configured to, in response to determining that the device cycle count is greater than the threshold cycle count, produce signals for causing a service notification to be displayed to at least one operator of the pneumatic device 12. For example, in some embodiments, the analyzer 30 may be configured to cause a service notification email or message to be sent to at least one operator of the pneumatic device 12. In some embodiments, the service notification may include replacement pneumatic device ordering information. For example, in some embodiments the service notification may include an offer to obtain a replacement pneumatic device with a few clicks on their mobile device.

In some embodiments, the analyzer 30 may be configured to determine a remaining cycle count, the remaining cycle count being a difference between a milestone cycle count and the device cycle count. In some embodiments, the milestone cycle count may be a cycle count at which a milestone is expected and/or an action is expected or suggested with respect to the pneumatic device 12. For example, in some embodiments, the milestone cycle count may be a predicted end of life cycle count at which the pneumatic device 12 is expected to fail or a suggested service cycle count at which a service of the pneumatic device 12 is suggested. The analyzer 30 may be configured to produce signals for causing a representation of the remaining cycle count to be displayed to an operator.

In some embodiments, the analyzer 30 may be configured to determine a predicted cycling rate, the predicted cycling rate representing a predicted number of cycles that the pneumatic device will be used for during a future time period. In various embodiments, the analyzer 30 may be configured to determine a device action date based at least in part on the predicted cycling rate and the remaining cycle count, and to produce signals for causing a representation of the device action date to be displayed to an operator. In some embodiments, where the milestone cycle count is a predicted end of life cycle count, the device action date may be device failure date. In some embodiments, where, for example, the milestone cycle count is a suggested service cycle count, the device action date may be a suggested device service date. In various embodiments, the device action date may be presented to the operator in the form of an alert or a calendar, for example.

In various embodiments, alternative or additional processing of one or more device cycle counts received from the counter 14 may be performed by the analyzer 30, which may facilitate active monitoring and maintenance of the pneumatic device 12 and/or the system 10.

### Counter

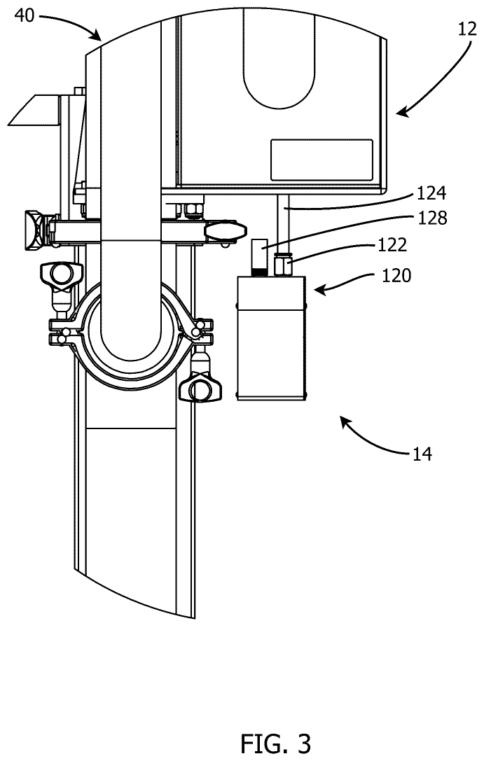

Referring now to FIG. 3, a portion 40 of the system 10 shown in FIG. 2 including the counter 14 is shown in greater detail. Referring to FIG. 3, in various embodiments, the counter 14 may include a fluid collector 120 having an inlet 122 configured to receive fluid flow from the pneumatic device 12. For example, in various embodiments, the inlet 122 may act as an inlet port and be connectable to an exhaust port 124 of the pneumatic device 12. For example, in some embodiments, the inlet 122 may be connected to a directional control valve exhaust port of the pneumatic device 12.

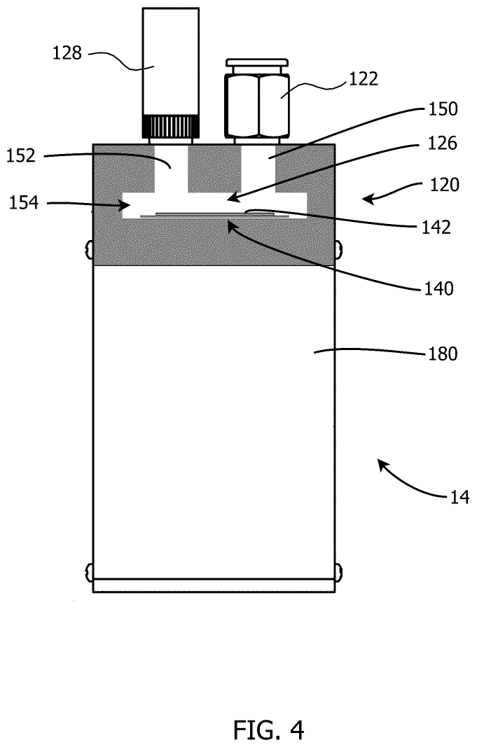

Referring to FIG. 4, the counter 14 is shown with a cross sectional view of the fluid collector 120, to show the inner workings of the fluid collector, in accordance with various embodiments. In various embodiments, the inlet 122 may be coupled to a passage 126, which may in turn be coupled to an outlet 128 configured to output the fluid flow. In various embodiments, the outlet 128 may include a muffler, for example.

In various embodiments, during operation, when the pneumatic device 12 outputs exhaust (e.g., when control valve exhaust is expelled, once per cycle of the pneumatic device 12), the inlet 122 may receive exhaust fluid or gas from the exhaust port 124 of the pneumatic device 12 and the fluid may flow through the passage 126 and out of the outlet 128. In various embodiments, the passage 126 may be generally U-shaped. In various embodiments, there may be little pressure drop between the inlet 122 and the outlet 128. In various embodiments, the pressure drop may be equivalent to the resistance of a pneumatic hose with the same air travel path. This resistance is very small thereby creating low pressure drop across it. In various embodiments, high pressure drop may be undesirable because that may indicate high resistance on the exhaust path, which should be avoided.

Referring still to FIG. 4, in various embodiments, the counter 14 may include a sensor 140 configured to sense the fluid flow in the passage 126 of the fluid collector 120. In various embodiments, the sensor 140 may include a piezo crystal transducer, which in some embodiments may include a piezo crystal plate transducer, for example. In some embodiments, additional or alternative sensors may be used, such as, for example, a mechanical pressure relay switch or another sensor configured to sense fluid flow in the passage 126. In various embodiments, use of a piezo crystal transducer may facilitate inexpensive, durable and/or low energy detection of strong intense fluid or air flow associated with the pneumatic device 12 while limiting pneumatic resistance, to produce a signal that may facilitate identification of use cycles for the pneumatic device 12. In various embodiments, use of a piezo crystal transducer may facilitate isolation of the sensor 140 in the passage 126, where it may be exposed to moisture from the pneumatic device 12.

In various embodiments, using the piezo crystal transducer may cost in the range of 1/10th the cost of other sensors, such as, for example, mechanical switches. In various embodiments, the piezo crystal transducer may be durable and may withstand a virtually infinite number of cycles due to its oscillating nature compared to other sensors, such as, for example, inexpensive mechanical pressure relay switches that may withstand 100,000-1,000,000 cycles of operation. In various embodiments, use of the piezo crystal transducer may facilitate the counter 14 being more durable than the pneumatic device 12 itself, which may be required since the counter 14 may be meant to facilitate monitoring of the pneumatic device 12 throughout its entire lifespan.

In some embodiments, the piezo crystal transducer may be more resilient to withstand contamination from food products than other sensors, such as, for example, inexpensive mechanical pressure relay switches. In some embodiments, using the piezo crystal transducer may facilitate use of a passive component that does not require any additional power source to convert mechanical signal energy into electrical signal energy compared to other sensors, such as pressure transducers, for example, that may constantly consume power when sampling a pressure level. In various embodiments, use of the piezo crystal transducer may facilitate the counter 14 running on low power, which may provide various advantages described herein, including allowing the counter 14 to be powered by battery (for about 2 years without battery replacement, in some embodiments, for example), without access to a solar power, a wall electrical outlet or other large power source.

In some embodiments, use of the piezo crystal transducer may allow the arrangement to have little and/or virtually no pressure drop across the counter 14 compared to use of another sensor such as a pressure transducer or a mechanical switch which may require having a larger pressure drop to detect the fluid flow. In various embodiments, this low pressure drop may be desirable to avoid or reduce any effect on functionality of the pneumatic device 12.

In various embodiments, the fluid collector 120 may include a fluid redirecting surface 142 in the passage 126 configured to cause a change in direction of the fluid flow received from the inlet 122. In some embodiments, the sensor 140 may be configured to sense forces on the fluid redirecting surface 142. In various embodiments, for example, a plate of the sensor 140 may act as or be included in the fluid redirecting surface 142. In some embodiments, the piezo crystal transducer acting as the sensor 140 may be configured to sense forces and so forces by the fluid flow may be more easily sensed when the fluid redirecting surface 142 redirects the fluid flow substantially. In some embodiments, the fluid redirecting surface 142 may be configured to cause at least about a 90 degree change in direction of the fluid flow. For example, in various embodiments, the fluid redirecting surface 142 may be generally perpendicular or normal to a direction of fluid flow received from the inlet 122 as shown in FIG. 4. In some embodiments, the fluid redirecting surface 142 may include a flat surface having a face that is normal to the direction of incoming fluid flow, as shown in FIG. 4, to cause a 90 degree change in direction of the fluid flow, for example. In some embodiments, a change in direction of at least about 90 degrees may facilitate accurate sensing of the fluid flow by a force sensor, such as a piezo crystal transducer, for example.

Referring still to FIG. 4, in some embodiments, the passage 126 may include an input portion 150, an output portion 152, and a sensing portion 154 coupled between the input portion 150 and the output portion 152. In some embodiments, the input and output portions 150 and 152 may be generally parallel and configured to facilitate movement of the fluid flow in opposite directions, and the sensing portion 154 may include at least one fluid redirecting surface configured to cause a change in direction of the fluid flow. In various embodiments, the at least one fluid redirecting surface included in the sensing portion 154 may include the fluid redirecting surface 142 and additional fluid redirecting surfaces that together cause fluid flow to change direction by about 180 degrees from the input portion 150 compared to fluid flow in the output portion 152. In various embodiments, causing about a 180 degree change in direction of the fluid flow in the sensing portion 154 may facilitate high forces being applied to the sensor 140 included in the sensing portion 154 and/or accurate sensing of the fluid flow by the force sensor 140, which in various embodiments may include a piezo crystal transducer, for example.

Referring still to FIG. 4, in some embodiments, two wires may be soldered to opposite polarities at respective sides of the sensor 140, and the wires may extend to an isolated electronics compartment 180, which may be waterproof, for example. In various embodiments, the electronics compartment 180 may contain environmentally sensitive electronics included in the counter 14.

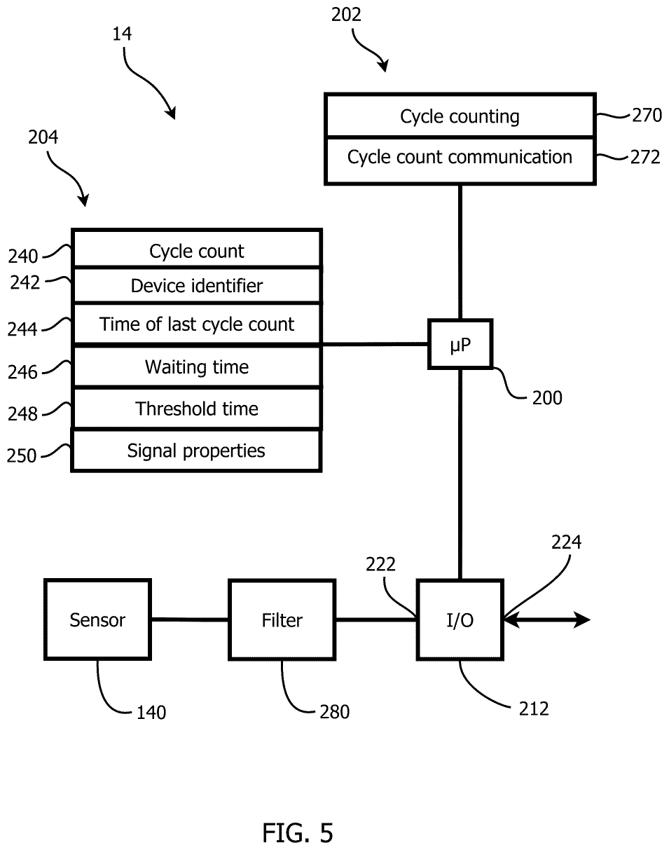

Referring now to FIG. 5, a schematic view of electronic elements included in the counter 14 shown in FIGS. 1 to 4 according to various embodiments is shown. Referring to FIG. 5, the counter 14 includes a processor circuit including a counter processor 200 and a program memory 202, a storage memory 204, and an input/output (I/O) interface 212, all of which are in communication with the counter processor 200. In various embodiments, processor circuit including the counter processor 200, program memory 202, storage memory 204, and I/O interface 212 may be implemented using a microcontroller. In various embodiments, the counter processor 200 may include one or more processing units, which may each include, for example, a central processing unit (CPU), a graphical processing unit (GPU), and/or a field programmable gate array (FPGA). In some embodiments, any or all of the functionality of the counter 14 described herein may be implemented using one or more FPGAs.

In some embodiments, the counter 14 also includes the sensor 140, and a sensed fluid signal filter 280 in communication with the sensor 140 and the counter processor 200.

In some embodiments, the sensed fluid signal filter 280 may be in communication with the counter processor 200 via an interface 222 of the I/O interface 212. In some embodiments, the interface 222 may facilitate analog electrical voltage reception and conversion to a digital representation. For example, in some embodiments, the interface 222 may be a digital input pin on a microcontroller looking for a voltage of 1.8V or 0V to represent Boolean digital high or low voltage respectively. In some embodiments, the I/O interface 212 may include an interface 224 for communicating with the aggregator 16 shown in FIGS. 1 and 2. In some embodiments, the interface 224 may facilitate wireless communication, such as, for example Bluetooth™ communication. In some embodiments, each of the interfaces included in the I/O interface 212 may include one or more interfaces and/or some or all of the interfaces included in the I/O interface 212 may be implemented as combined interfaces or a single interface.

In some embodiments, where a device is described herein as receiving or sending information, it may be understood that the device receives signals representing the information via an interface of the device or produces signals representing the information and transmits the signals to the other device via an interface of the device.

Processor-executable program codes for directing the counter processor 200 to carry out various functions are stored in the program memory 202. Referring to FIG. 5, the program memory 202 includes a block of codes 270 for directing the counter 14 to perform pneumatic device cycle counting to facilitate pneumatic device monitoring and a block of codes 272 for directing the counter 14 to perform pneumatic device cycle count communication to facilitate pneumatic device monitoring. In this specification, it may be stated that certain encoded entities such as applications or modules perform certain functions. Herein, when an application, module or encoded entity is described as taking an action, as part of, for example, a function or a method, it will be understood that at least one processor (e.g., the counter processor 200) is directed to take the action by way of programmable codes or processor-executable codes or instructions defining or forming part of the application.

The storage memory 204 includes a plurality of storage locations including location 240 for storing cycle count information, location 242 for storing pneumatic device identifier information, location 244 for storing time of last cycle count information, location 246 for storing waiting time information, location 248 for storing threshold time information, and location 250 for storing signal property data. In various embodiments, the storage locations may be stored in a database in the storage memory 204.

In various embodiments, the block of codes 270 may be integrated into a single block of codes or portions of the block of code 270 may include one or more blocks of code stored in one or more separate locations in the program memory 202. In various embodiments, any or all of the locations 240-250 may be integrated and/or each may include or be included in one or more separate locations in the storage memory 204.

Each of the program memory 202 and storage memory 204 may be implemented as one or more storage devices including random access memory (RAM), a hard disk drive (HDD), a solid-state drive (SSD), a network drive, flash memory, a memory stick or card, any other form of non-transitory computer-readable memory or storage medium, and/or a combination thereof. In some embodiments, the program memory 202, the storage memory 204, and/or any portion thereof may be included in a device separate from the counter 14 and in communication with the counter 14 via the I/O interface 212, for example.

In various embodiments, the sensed fluid signal filter 280, counter processor 200, program memory 202, storage memory 204, and I/O interface 212 may be housed in the electronics compartment 180 shown in FIG. 4.

### Counter Operation

Referring to FIG. 4, when the fluid flow from the pneumatic device 12 engages or hits the sensor 140 and is redirected by the fluid redirecting surface 142, the sensor 140 may generate a voltage signal which may act as a sensed fluid signal. In some embodiments, the voltage signal may be transmitted to the sensed fluid signal filter 280 shown in FIG. 5.

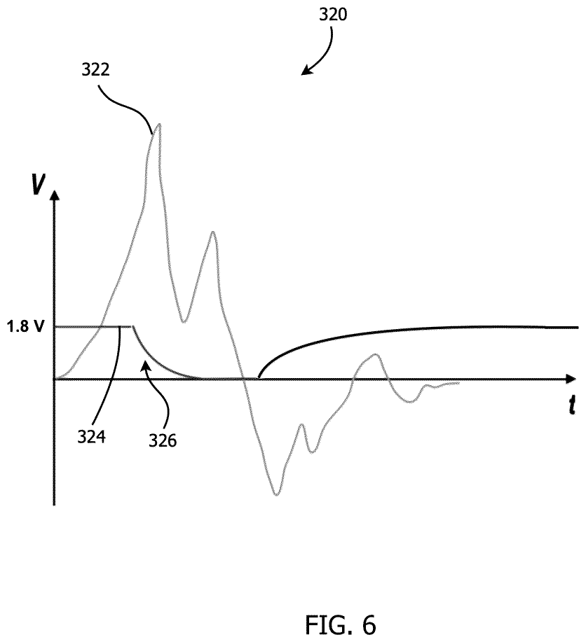

Referring to FIG. 6, there is shown a graph 320 which depicts a representation of the sensed fluid signal 322 that may be generated by the sensor 140 and transmitted to the sensed fluid signal filter 280 in accordance with various embodiments.

Referring to FIG. 5, the sensed fluid signal filter 280 may be configured to receive the sensed fluid signal from the sensor 140, filter the sensed fluid signal to generate a filtered representation of the sensed fluid signal, and cause the filtered representation to be transmitted to the counter processor 200 shown in FIG. 5.

In various embodiments, the sensed fluid signal filter 280 may be configured to smooth spikes of the sensed fluid signal that is received from the sensor 140. In some embodiments, the sensed fluid signal filter 280 may include a low pass filter configured to filter high frequency components out of the sensed fluid signal. In various embodiments, the low pass filter may act as an averaging filter to reduce or prevent false triggering. In some embodiments, the fluid flow sensed may include a blast of air for each cycle, which may cause multiple high amplitude peaks of oscillation in the sensed fluid signal, which if not smoothed may cause the counter 14 to falsely interpret each peak as a new cycle. In some embodiments, using the sensed fluid signal filter 280 to smooth may facilitate detection of one edge of the sensed fluid signal per cycle, as will be described in further detail below.

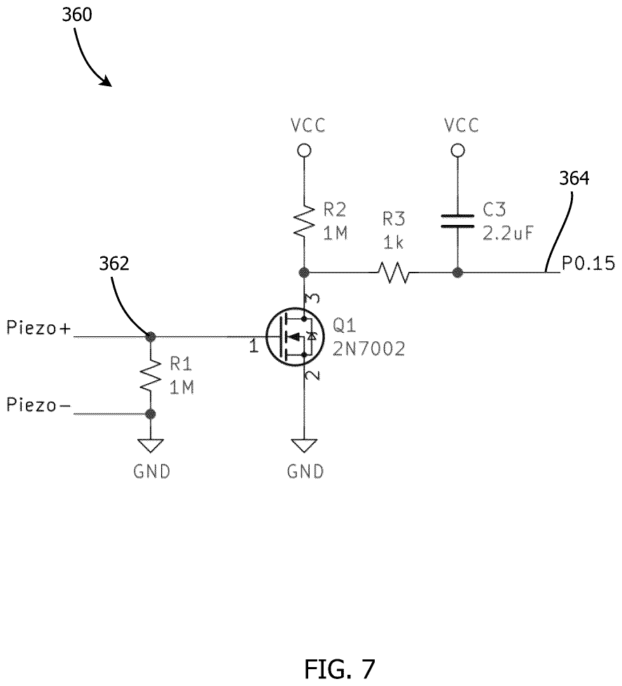

Referring to FIG. 7, there is shown a schematic diagram 360 of elements that may be included in the sensed fluid signal filter 280 in accordance with various embodiments. In various embodiments, the sensed fluid signal may be generated or input at 362 and the filtered representation of the sensed fluid signal may be output at 364, which may be in communication with the interface 222 of the I/O interface 212 shown in FIG. 5, for example. In some embodiments, the sensed fluid signal filter 280 may have a cut off frequency (at −3 dB gain) of about 72 Hz (corresponding to time constant of 2.20 ms) in response to an input step signal from 0V to 3V. In some embodiments, the sensed fluid signal filter 280 may have a cut off frequency (at −3 dB gain) of about 72 mHz (corresponding to time constant of 2.20 s) in response to an input step signal from 3V to 0V.

Referring to FIG. 6, a filtered representation 324 of the sensed fluid signal that may be generated by the sensed fluid signal filter 280 based on the sensed fluid signal 322 in accordance with various embodiments is shown.

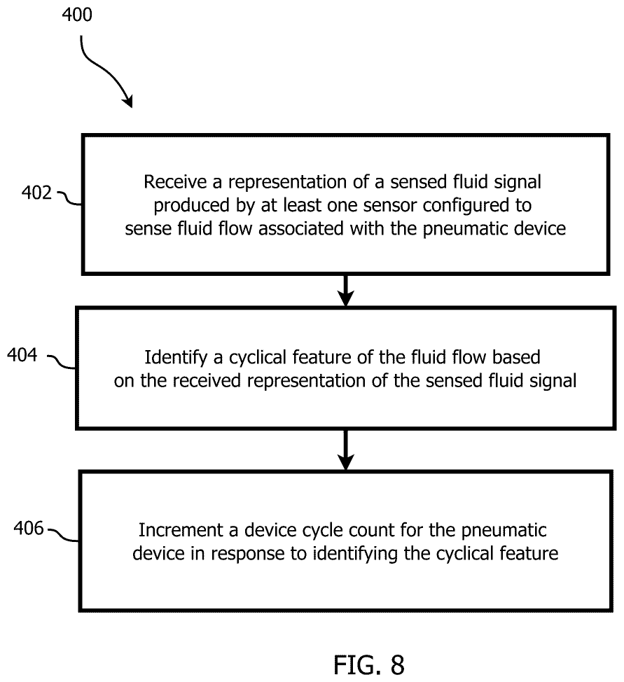

Referring now to FIG. 8, a flowchart depicting blocks of code for directing the counter processor 200 shown in FIG. 5 to perform pneumatic device cycle counting functions in accordance with various embodiments is shown generally at 400. The blocks of code included in the flowchart 400 may be encoded in the block of codes 270 of the program memory 202 shown in FIG. 5, for example.

Referring to FIG. 8, the flowchart 400 begins with block 402, which directs the counter processor 200 to receive a representation of a sensed fluid signal produced by at least one sensor configured to sense fluid flow associated with the pneumatic device 12. In various embodiments, block 402 may direct the counter processor 200 to receive the filtered representation 324 shown in FIG. 6, for example, from the sensed fluid signal filter 280, via the interface 222 of the I/O interface shown in FIG. 5.

Block 404 then directs the counter processor 200 to identify a cyclical feature of the fluid flow based on the received representation of the sensed fluid signal. For example, in various embodiments, the cyclical feature of the fluid flow may be the initial blast of fluid flow provided by the exhaust port 124 of the pneumatic device shown in FIG. 3. In various embodiments, this initial blast may occur only once per cycle of use of the pneumatic device 12.

In some embodiments, identifying the cyclical feature may involve identifying an edge or a digital edge in a filtered representation of the sensed fluid signal. In some embodiments, block 404 may direct the counter processor 200 to identify an edge of the filtered representation of the sensed fluid signal. In various embodiments, the edge of the filtered representation of the sensed fluid signal may be present in the filtered representation of the sensed fluid signal when the initial blast of fluid flow is provided by the exhaust port 124 is sensed by the sensor 140 shown in FIG. 4. In various embodiments, an edge may be identified when voltage from the filtered representation of the sensed fluid signal changes from a high logic state to a low logic state or from a low logic state to a high logic state, for example.

In some embodiments, block 404 may direct the counter processor 200 to trigger an interrupt/wake-up event upon identifying a negative edge of the filtered representation of the sensed fluid signal (i.e., when the signal changes from high to low). Referring to FIG. 6, a negative edge of the filtered representation 324 of the sensed fluid signal that may be identified at block 404 is shown at 326.

In various embodiments, block 406 may direct the counter processor 200 to increment a device cycle count for the pneumatic device 12 in response to identifying the cyclical feature. For example, in some embodiments, a device cycle count may have previously been initialized to zero when the pneumatic device 12 was newly installed and may be stored in the location 240 of the storage memory 204. In various embodiments, block 406 may direct the counter processor 200 to increment the device cycle count stored in the location 240 of the storage memory 204. In some embodiments, for example, the counter 14 may include a Bluetooth™ Low Energy device and the device cycle count may be stored as a cycle count value characteristic of a Generic Attribute Profile (GATT) of the Bluetooth™ Low Energy device. In some embodiments, for example, after block 406 of the flowchart 400 shown in FIG. 8 is executed, a 4 byte unsigned integer little endian value representing the device cycle count may be stored in the location 240 of the storage memory 204.

In some embodiments, block 406 may direct the counter processor 200 to update a time of last cycle count stored in the location 244 of the storage memory 204, to reflect the current time or time at which the device cycle count was last incremented as the time of the last cycle count. In various embodiments, block 406 may direct the counter processor 200 to store the time in the location 244.

In various embodiments, the flowchart 400 may be executed repeatedly and/or continuously such that the device cycle count stored in the location 240 of the storage memory 204 is incremented each time a cyclical feature is identified at block 404. In various embodiments, this may facilitate keeping the device cycle count stored in the location 240 of the storage memory 204 up to date as representative of a total number of cycles for which the pneumatic device 12 has been used.

In some embodiments, the storage memory 204 may have stored thereon additional information. For example, in some embodiments, the storage memory 204 may include the location 242 for storing a pneumatic device identifier which may have been previously provided and/or which may uniquely identify the pneumatic device 12. For example, in some embodiments, a Bluetooth™ MAC address for the counter 14 may act as the pneumatic device identifier. In some embodiments, the MAC address may be associated with another pneumatic device identifier or a machine serial number string identifying the pneumatic device 12 and that association may be stored in the system 10, such as at the aggregator 16 or the analyzer 30. In various embodiments, the pneumatic device identifier may have been previously generated or provided, such as, when the counter 14 hardware was manufactured or during setup when the counter 14 was first coupled to the pneumatic device 12.

In some embodiments, the storage memory 204 may include locations storing additional or alternative information relating to the pneumatic device 12 and/or the counter 14, such as, for example, a temperature level value, a battery level value, a manufacturing name string, a hardware revision string, a firmware revision string, and/or an additional or alternative pneumatic device identifier, such as, for example, a machine serial number string for the pneumatic device 12.

Referring to FIGS. 1 and 2, in various embodiments, the program memory 202 of the counter 14 may have stored thereon the block of codes 272 for directing the counter 14 to perform pneumatic device cycle count communication to facilitate pneumatic device monitoring. In various embodiments, the block of codes 272 may direct the counter processor 200 to produce signals for causing a representation of the device cycle count to be transmitted to the analyzer 30. In various embodiments, the analyzer 30 may be separately powered from the counter 14. In various embodiments, having the counter 14 merely send on the device cycle count so that analysis may be done by a separately powered analyzer may facilitate keeping power consumption by the counter 14 low. In some embodiments, the aggregator 16 may act as an intermediary or relay for relaying the device cycle count and/or other information to the analyzer 30. In some embodiments, including the aggregator 16 between the counter 14 and the analyzer 30 may enable the counter 14 to be able to transmit the device cycle counts using low power while keeping the analyzer 30 off site and thus may facilitate keeping power consumption by the counter 14 and/or the aggregator 16 low. In various embodiments, the analyzer 30 may be configured to receive the representation of the device cycle count and perform analysis on the device cycle count.

In some embodiments, the block of codes 272 may direct the counter processor 200 to periodically send information including the device cycle count to the aggregator 16. In some embodiments, this may be triggered by the aggregator 16, which may be configured to use wireless communication to find available nearby counters (such as the counter 14, for example) and to establish connections with them to receive the information including the device cycle count. In some embodiments, the aggregator 16 may be configured to periodically scan, connect, request and receive the information including the device cycle count and to send the information to the analyzer 30. For example, in some embodiments, the aggregator 16 may be configured to request information from the counter 14 every about 3 hours.

In some embodiments, the block of codes 272 may direct the counter processor 200 to intermittently advertise the counter 14 as ready for connection, such that the counter 14 is available for connection to the aggregator 16, only when the pneumatic device 12 is active. For example, in some embodiments, the counter 14 may be configured to enter an inactive state or sleep mode when the pneumatic device 12 is inactive. In various embodiments, this may facilitate reduced power usage by the counter 14, which may facilitate powering of the counter 14 by battery and/or longer battery life for the counter 14.

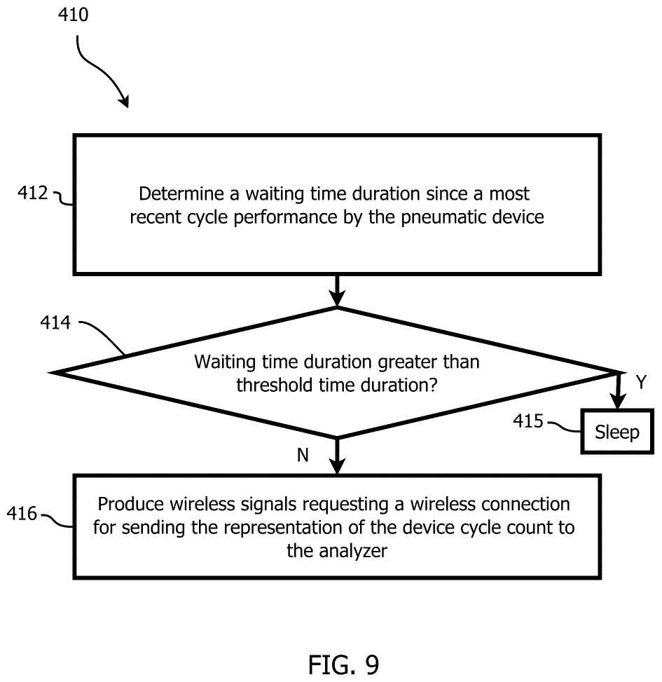

Referring to FIG. 9, there is shown a flowchart 410 depicting blocks of code for directing the counter processor 200 shown in FIG. 5 to perform pneumatic device cycle count communication functions in accordance with various embodiments. The blocks of code included in the flowchart 410 may be encoded in the block of codes 272 of the program memory 202 shown in FIG. 5, for example. In various embodiments, the flowchart 410 may be executed repeatedly or continuously to facilitate communication of the device cycle count with the aggregator 16 and the analyzer 30 shown in FIGS. 1 and 2.

Referring to FIG. 9, the flowchart 410 begins with block 412 which directs the counter processor 200 to determine a waiting time duration since a most recent cycle performance by the pneumatic device. In various embodiments, block 412 may direct the counter processor 200 to determine the waiting time as a difference between the time of last cycle count stored in the location 244 of the storage memory 204 and a current time. In various embodiments, block 412 may direct the counter processor to store the waiting time duration in the location 246 of the storage memory 204.

Referring to FIG. 9, block 414 directs the counter processor 200 to compare the waiting time duration with a threshold time duration to determine whether the waiting time duration is greater than the threshold time duration. In various embodiments, the threshold time duration may have been previously provided and stored in the location 248 of the storage memory 204. In various embodiments, for example, the threshold time duration stored in the location 248 of the storage memory 204 may be a time duration after which, it can be assumed that the pneumatic device 12 is not operating and so the counter 14 should enter a sleep state. In some embodiments, the threshold time duration may be greater than 5 seconds. In various embodiments, the threshold time duration being greater than 5 seconds may help to avoid the counter 14 entering a sleep state while the pneumatic device 12 is still operating.

In some embodiments, the threshold time duration may be greater than 10 minutes. In various embodiments, the threshold time duration being greater than 10 minutes may help to avoid the counter 14 entering a sleep state when the pneumatic device has been paused or is not being used temporarily. In some embodiments, the threshold time duration may be less than 120 minutes. In various embodiments, the threshold time duration being less than 120 minutes may facilitate power savings. In some embodiments, for example, the threshold time duration may be 30 minutes. In some embodiments, the threshold time duration may be configurable by an operator of the system 10.

Referring to FIG. 9, if the waiting time duration is less than the threshold time duration, block 414 may direct the counter processor 200 to proceed to block 416, which directs the counter processor 200 to produce wireless signals requesting a wireless connection for sending the representation of the device cycle count to the analyzer. In some embodiments, block 416 may direct the counter processor 200 to broadcast a Bluetooth™ advertising packet that signals that the counter 14 is available for connection. In some embodiments, the advertising packet may include a pneumatic device identifier for the pneumatic device 12.

If at block 414, the counter processor determines that the waiting time duration is not less than the threshold time duration, then block 414 may direct the counter processor to proceed to block 415 and enter a sleep mode. In sleep mode, the counter 14 will not broadcast wireless signals requesting a wireless connection, which may preserve the battery life. In various embodiments, when a new cycle is performed by the pneumatic device 12, the counter 14 may be woken up by an interrupt from the interface 222 of the I/O interface 212 pin and the flowchart 410 and/or block 416 of the flowchart 410 may be executed.

When block 416 has been executed, the aggregator 16 shown in FIGS. 1 and 2 has the opportunity to request and receive a representation of the device cycle count. In various embodiments, the flowchart 410 may be executed continuously or repeatedly such that the counter 14 is continuously or repeatedly advertising a wireless connection for the aggregator 16 as long as the counter 14 is not in sleep mode.

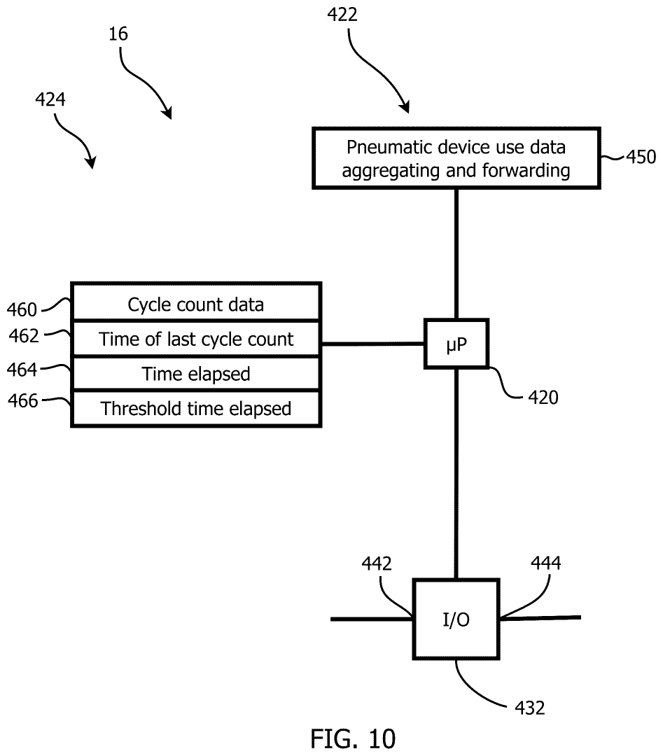

In some embodiments, the aggregator 16 shown in FIGS. 1 and 2 may include a device such as, a stationary computer, a mobile device, a mobile phone, a tablet, or another computing device configured to communicate with the counter 14 and having an Internet connection, and the aggregator 16 may have running thereon an application which directs the aggregator 16 to periodically send a device cycle information request to the counter 14. Referring to FIG. 10, there is shown a schematic view of the aggregator 16 according to various embodiments. Referring to FIG. 10, the aggregator 16 includes a processor circuit including an aggregator processor 420 and a program memory 422, a storage memory 424, and an input/output (I/O) interface 432, all of which are in communication with the aggregator processor 420. In various embodiments, the aggregator processor 420 may include one or more processing units, which may each include, for example, a central processing unit (CPU), a graphical processing unit (GPU), and/or a field programmable gate array (FPGA). In some embodiments, any or all of the functionality of the aggregator 16 described herein may be implemented using one or more FPGAs.

The I/O interface 432 includes an interface 442 for communicating with the counter 14 and any other counters and an interface 444 for communicating with the analyzer 30 via the network 32 as shown in FIGS. 1 and 2. In some embodiments, the interface 442 may facilitate a wireless Bluetooth™ connection with the counter 14. In some embodiments, the interface 444 may facilitate a wireless communication with the network 32 for communicating with the analyzer 30, such as, for example, by providing a WiFi™ or mobile internet connection wherein the network 32 may include the Internet, for example.

Processor-executable program codes for directing the aggregator processor 420 to carry out various functions are stored in the program memory 422. Referring to FIG. 10, the program memory 422 includes a block of codes 450 for directing the aggregator 16 to perform pneumatic device use data aggregating and forwarding functions.

The storage memory 424 includes a plurality of storage locations including location 460 for storing device cycle count data, location 462 for storing time of last cycle count data, location 464 for storing time elapsed data, and location 466 for storing threshold time elapsed data. In various embodiments, the plurality of storage locations may be stored in a database in the storage memory 424.

In various embodiments, the block of codes 450 may be integrated into a single block of codes or portions of the block of codes 450 may include one or more blocks of code stored in one or more separate locations in the program memory 422. In various embodiments, any or all of the locations 460-466 may be integrated and/or each may include one or more separate locations in the storage memory 424.

Each of the program memory 422 and storage memory 424 may be implemented as one or more storage devices including random access memory (RAM), a hard disk drive (HDD), a solid-state drive (SSD), a network drive, flash memory, a memory stick or card, any other form of non-transitory computer-readable memory or storage medium, and/or a combination thereof. In some embodiments, the program memory 422, the storage memory 424, and/or any portion thereof may be included in a device separate from the aggregator 16 and in communication with the aggregator 16 via the I/O interface 432, for example. In some embodiments, the functionality of the aggregator processor 420 and/or the aggregator 16 as described herein may be implemented using a plurality of processors and/or a plurality of devices.

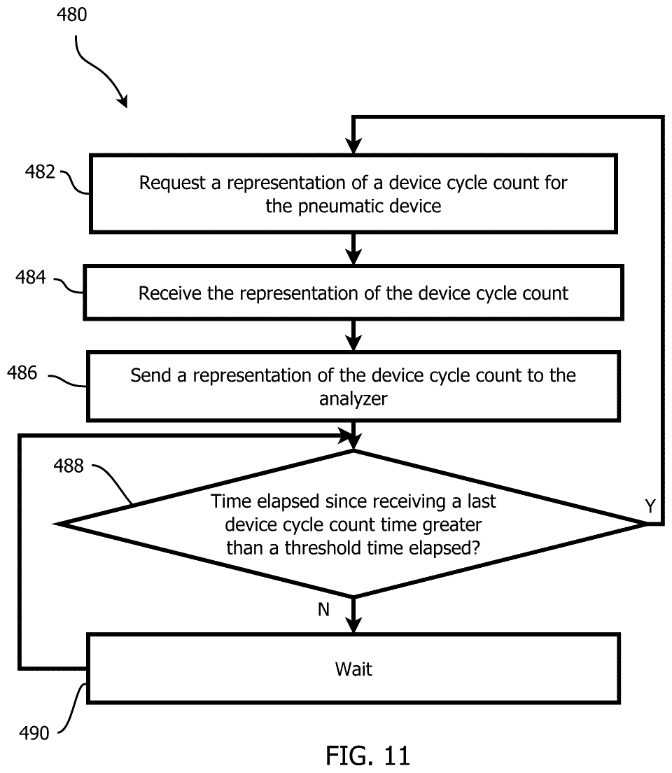

In various embodiments, the aggregator 16 may be configured to perform pneumatic device use data aggregating functions involving requesting and receiving one or more received device cycle counts. For example, referring now to FIG. 11, a flowchart depicting blocks of code for directing the aggregator processor 420 shown in FIG. 10 to perform pneumatic device use data aggregating and forwarding functions in accordance with various embodiments is shown generally at 480. The blocks of code included in the flowchart 480 may be encoded in the block of codes 450 of the program memory 422 shown in FIG. 10, for example.

Referring to FIG. 11, the flowchart 480 begins with block 482, which directs the aggregator processor 420 to request a representation of a device cycle count for the pneumatic device. In various embodiments, block 482 may direct the aggregator processor 420 to receive via the interface 442 of the I/O interface 432 shown in FIG. 10, the Bluetooth™ advertising wireless signals produced by the counter 14 at block 416 of the flowchart 410 shown in FIG. 9 and to send a device cycle information request to the counter 14. In various embodiments, block 482 may direct the aggregator processor 420 to establish a Bluetooth™ connection with the counter 14.

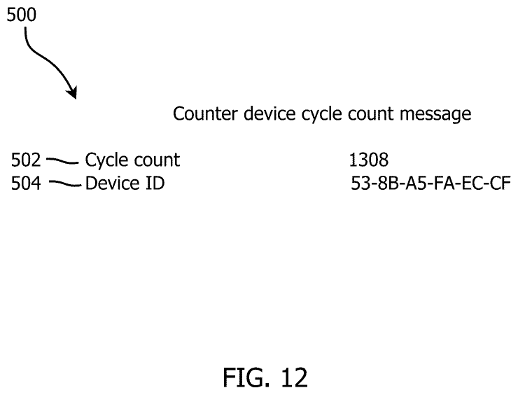

In various embodiments, the counter 14 may be configured to produce signals for causing a representation of the device cycle count to be transmitted to the analyzer 30 in response to receiving the device cycle information request. In various embodiments, the block of codes 272 shown in FIG. 5 may include blocks of code for directing the counter processor 200 to receive the device cycle information request from the aggregator 16, which may in various embodiments, include a GATT request to establish a Bluetooth™ connection, and to generate and transmit a counter device cycle count message 500 as shown in FIG. 12, to the aggregator 16. In some embodiments, the counter device cycle count message 500 may be transmitted from the counter 14 to the aggregator 16 via the Bluetooth™ connection.

Referring to FIG. 12, the counter device cycle count message 500 includes a device cycle count field 502 for storing a device cycle count for the pneumatic device 12 and a pneumatic device identifier field 504 for storing a pneumatic device identifier uniquely identifying the pneumatic device 12.

In various embodiments, the blocks of code may direct the counter processor 200 to, in response to receiving the request, retrieve the device cycle count from the location 240 of the storage memory 204 shown in FIG. 5 and to include it in the device cycle count field 502 of the counter device cycle count message 500. In various embodiments, the blocks of code may direct the counter processor 200 to, in response to receiving the request, retrieve the pneumatic device identifier from the location 242 of the storage memory 204 and to include it in the pneumatic device identifier field 504 of the counter device cycle count message 500.

The blocks of code may direct the counter processor 200 to send the counter device cycle count message 500 shown in FIG. 9 to the aggregator 16 via the interface 224 of the I/O interface 212, for example.

Referring to FIG. 11, block 484 may direct the aggregator processor 420 to receive the representation of the device cycle count from the counter 14. In various embodiments, block 484 may direct the aggregator processor 420 to receive and store the counter device cycle count message 500 shown in FIG. 12 in the location 460 of the storage memory 424 shown in FIG. 10. In various embodiments, block 484 may direct the aggregator processor 420 to update a time of last cycle count received in the location 462 of the storage memory 424, to reflect the current time as the time of receiving the last cycle count. Thus, in various embodiments, block 484 may direct the aggregator processor 420 to store a representation of the current time in the location 462 after receiving the counter device cycle count message 500. In various embodiments, the time of last cycle count may be stored in association with the pneumatic device identifier for the pneumatic device 12.

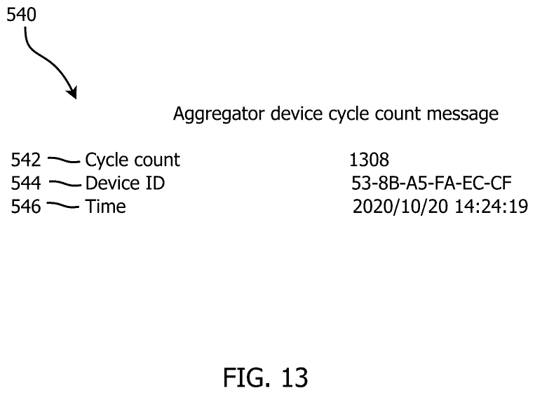

Referring to FIG. 11, block 486 directs the aggregator processor 420 to send a representation of the device cycle count to the analyzer 30. In various embodiments, block 486 may direct the aggregator processor 420 to generate an aggregator device cycle count message 540 as shown in FIG. 13 and to send the aggregator device cycle count message 540 to the analyzer 30 via the interface 444 of the I/O interface 432 shown in FIG. 10 and the network 32 shown in FIGS. 1 and 2. Referring to FIG. 13, the aggregator device cycle count message 540 includes a device cycle count field 542 for storing the device cycle count taken from the device cycle count field 502 of the counter device cycle count message 500, a pneumatic device identifier field 544 for storing the pneumatic device identifier taken from the pneumatic device identifier field 504 of the counter device cycle count message 500, and a time field 546 for storing a time associated with the count, taken from the time of last cycle count stored in the location 462 of the storage memory 424 shown in FIG. 10. The aggregator 16 may be configured to send the aggregator device cycle count message 540 shown in FIG. 13 to the analyzer 30 shown in FIGS. 1 and 2, for example.

Referring to FIG. 11, in various embodiments, the flowchart 480 may continue at block 488, which directs the aggregator processor 420 to determine whether a time elapsed since receiving a last representation of a device cycle count is greater than a threshold time elapsed. In various embodiments, block 488 may direct the aggregator processor 420 to read the time of the last cycle count received from the location 462 of the storage memory 424 shown in FIG. 10 and to determine a difference between that time and a current time. In various embodiments, the difference may act as the time elapsed since receiving the last device cycle count. In various embodiments, block 488 may direct the aggregator processor to store the difference as a time elapsed since receiving the last device cycle count in the location 464 of the storage memory 424 shown in FIG. 10. In various embodiments, the time elapsed may be stored in association with the pneumatic device identifier for the pneumatic device 12.

In various embodiments, block 488 may direct the aggregator processor 420 to compare the time elapsed stored in the location 464 of the storage memory 424 to a threshold time elapsed from the location 466 of the storage memory 424. In various embodiments, the threshold time elapsed may have been previously provided as a minimum interval between requesting device cycle counts from the counter 14 by the aggregator 16. In various embodiments, using a minimum interval before requesting a device cycle count may facilitate power savings by the aggregator and/or the counter 14. In some embodiments, the threshold time elapsed may be greater than 10 minutes. In some embodiments, the threshold time elapsed being greater than 10 minutes may facilitate battery power savings by the aggregator 16 and the counter 14. For example, in some embodiments, the threshold time elapsed may be about 3 hours. In various embodiments, the threshold time elapsed may be stored in association with the pneumatic device identifier.

In various embodiments, block 488 may direct the aggregator processor 420 to, if the time elapsed is greater than the threshold time elapsed, return to block 482 and request an updated representation of a device cycle count for the pneumatic device 12.

In various embodiments, block 488 may direct the aggregator processor 420 to, if the time elapsed is not greater than the threshold time elapsed, proceed to block 490 and wait before re-executing block 488. Accordingly, in various embodiments, execution of the flowchart 480 shown in FIG. 11 may facilitate periodic request and reception of counter device cycle count messages, such as the counter device cycle count message 500 shown in FIG. 12, from the counter 14 shown in FIGS. 1 and 2, and consequent periodic transmission of aggregator device cycle count messages, such as the aggregator device cycle count message 540, to the analyzer 30.

### Analyzer

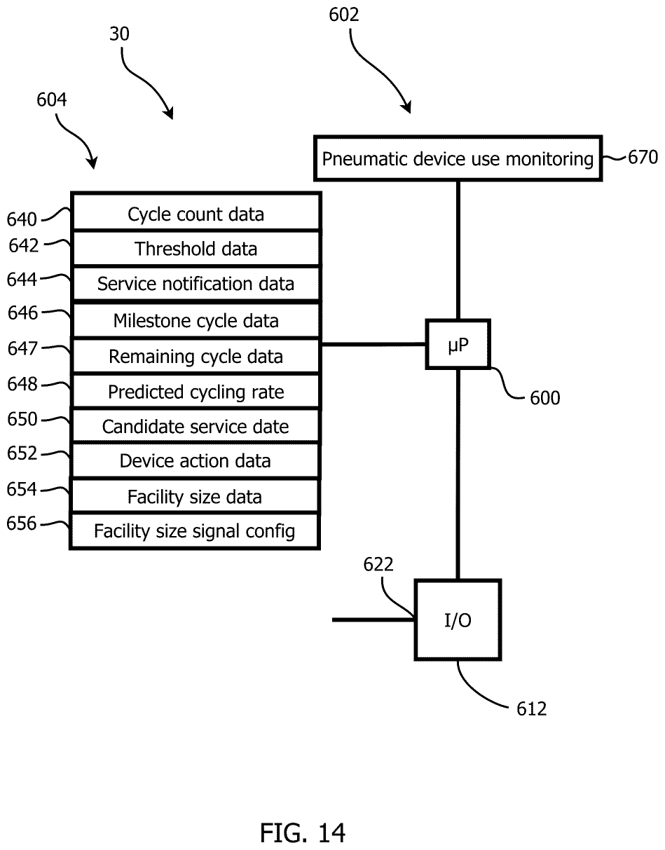

Referring now to FIG. 14, there is shown a schematic view of the analyzer 30 shown in FIGS. 1 and 2 according to various embodiments. Referring to FIG. 14, the analyzer 30 includes a processor circuit including an analyzer processor 600 and a program memory 602, a storage memory 604, and an input/output (I/O) interface 612, all of which are in communication with the analyzer processor 600. In various embodiments, the analyzer processor 600 may include one or more processing units, which may each include, for example, a central processing unit (CPU), a graphical processing unit (GPU), and/or a field programmable gate array (FPGA). In some embodiments, any or all of the functionality of the analyzer 30 described herein may be implemented using one or more FPGAs.

The I/O interface 612 includes an interface 622 for communicating with the network 32 as shown in FIGS. 1 and 2. In some embodiments, the interface 622 may facilitate communication with the aggregator 16 via the network 32. In various embodiments, the network 32 may include the Internet, for example, such that communication with various other devices connected to the network 32, such as the operator device 38, for example, as shown in FIGS. 1 and 2, may be facilitated via the interface 622. In some embodiments, the interface 622 may facilitate wired communication. In some embodiments, the analyzer 30 or a virtual machine having architecture generally similar to the analyzer 30 shown in FIG. 14 may be implemented in one or more servers, such as, in the cloud for example.

Processor-executable program codes for directing the analyzer processor 600 to carry out various functions are stored in the program memory 602. Referring to FIG. 14, the program memory 602 includes a block of codes 670 for directing the analyzer 30 to perform pneumatic device use monitoring functions.

The storage memory 604 includes a plurality of storage locations including location 640 for storing cycle count data, location 642 for storing threshold data, location 644 for storing service notification data, location 646 for storing milestone cycle count data, location 647 for storing remaining cycle count data, location 648 for storing predicted cycling rate data, location 650 for storing candidate service date information, location 652 for storing device action data, location 654 for storing facility size data, and location 656 for storing facility size signal configuration data. In various embodiments, the plurality of storage locations may be stored in a database in the storage memory 604.

In various embodiments, the block of codes 670 may be integrated into a single block of codes or portions of the block of codes 670 may include one or more blocks of code stored in one or more separate locations in the program memory 602. In various embodiments, any or all of the locations 640-656 may be integrated and/or each may include one or more separate locations in the storage memory 604.

Each of the program memory 602 and storage memory 604 may be implemented as one or more storage devices including random access memory (RAM), a hard disk drive (HDD), a solid-state drive (SSD), a network drive, flash memory, a memory stick or card, any other form of non-transitory computer-readable memory or storage medium, and/or a combination thereof. In some embodiments, the program memory 602, the storage memory 604, and/or any portion thereof may be included in a device separate from the analyzer 30 and in communication with the analyzer 30 via the I/O interface 612, for example. In some embodiments, the functionality of the analyzer processor 600 and/or the analyzer 30 as described herein may be implemented using a plurality of processors and/or a plurality of devices.

In various embodiments, the analyzer 30 may be configured to perform pneumatic device use monitoring functions involving analysis of one or more received device cycle counts. In various embodiments, the pneumatic device use monitoring functions may involve comparing the device cycle count to a threshold cycle count and alerting an operator when the device cycle count surpasses the threshold.

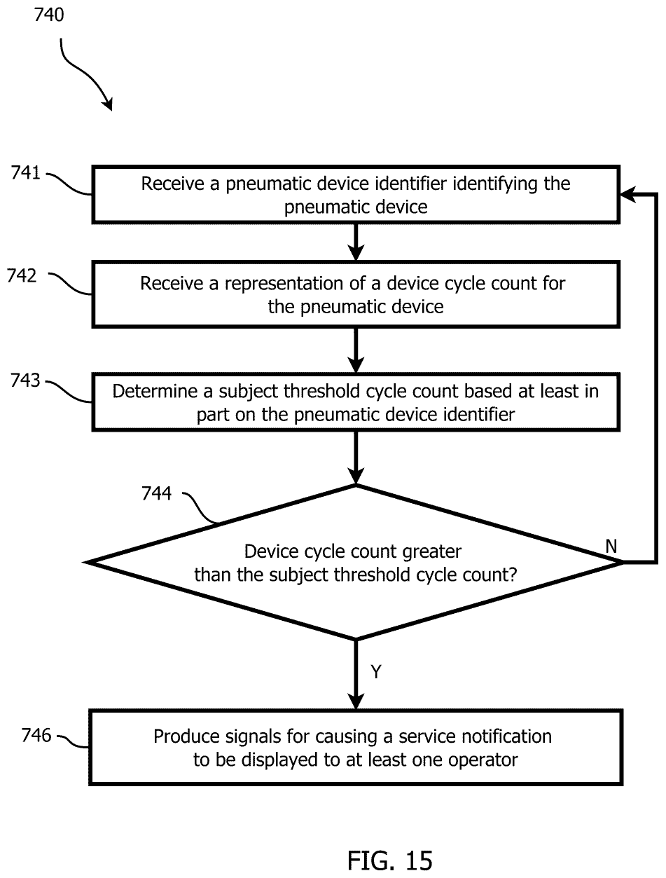

Referring now to FIG. 15, a flowchart depicting blocks of code for directing the analyzer processor 600 shown in FIG. 14 to perform pneumatic device use monitoring functions in accordance with various embodiments is shown generally at 740. The blocks of code included in the flowchart 740 may be encoded in the block of codes 670 of the program memory 602 shown in FIG. 14, for example.

Referring to FIG. 15, the flowchart 740 begins with block 741, which directs the analyzer processor 600 to receive a pneumatic device identifier identifying the pneumatic device. The flowchart 740 also includes block 742 which directs the analyzer processor 600 to receive a representation of a device cycle count for the pneumatic device 12. In various embodiments, blocks 741 and 742 may be executed concurrently to direct the analyzer processor 600 to receive the aggregator device cycle count message 540 shown in FIG. 13 from the aggregator 16 via the network 32 (shown in FIGS. 1 and 2) and the interface 622 of the I/O interface 612 shown in FIG. 14.

In some embodiments, blocks 741 and 742 may direct the analyzer processor 600 to read the device cycle count from the device cycle count field 542 of the aggregator device cycle count message 540 shown in FIG. 13 and to store the device cycle count in the location 640 of the storage memory 604 shown in FIG. 14. In some embodiments, blocks 741 and 742 may direct the analyzer processor 600 to store the device cycle count in association with the time at which the count was taken. In some embodiments, blocks 741 and 742 may direct the analyzer processor 600 to store the device cycle count in association with a pneumatic device identifier identifying the pneumatic device 12.

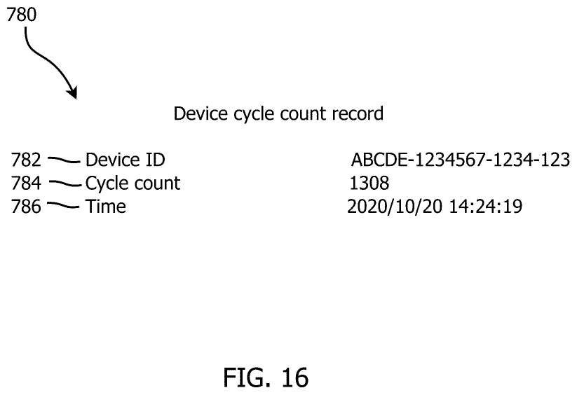

In some embodiments, blocks 741 and 742 may direct the analyzer processor 600 to generate a device cycle count record 780 as shown in FIG. 16 based on the message 540 shown in FIG. 13, the device cycle count record 780 including a pneumatic device identifier field 782, a cycle count field 784, and a time field 786. In various embodiments, blocks 741 and 742 may direct the analyzer processor 600 to fill the fields of the device cycle count record 780 using the corresponding values from the received aggregator device cycle count message. In some embodiments, blocks 741 and 742 may direct the analyzer processor 600 to look up another pneumatic device identifier associated with the pneumatic device identifier from the aggregator device cycle count message 540 and include that pneumatic device identifier in the field 782. For example, in some embodiments, an association between the Bluetooth™ MAC address of the counter 14 and a machine serial number string identifying the pneumatic device 12 may have been previously provided during setup of the counter 14 and the association may be stored in the storage memory 604. For example, in some embodiments, a UTF-8 String such as “ABCDE-1234567-1234-123” may be stored in association with the MAC address 53-8B-A5-FA-EC-CF. Blocks 741 and 742 may direct the analyzer processor 600 to store the device cycle count record 780 in the location 640 of the storage memory 604.

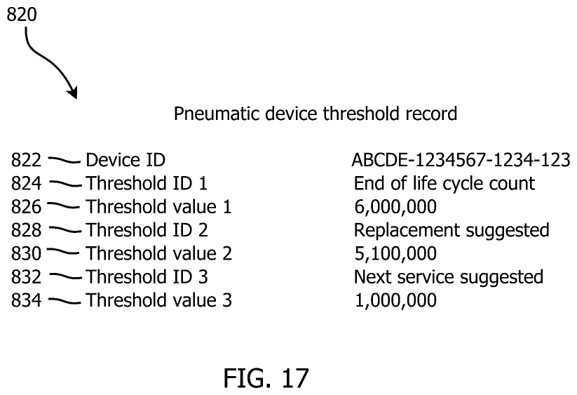

Referring to FIG. 15, block 743 directs the analyzer processor 600 to determine a subject threshold cycle count based at least in part on the pneumatic device identifier. In some embodiments, block 743 may direct the analyzer processor 600 to determine the threshold cycle count based on the pneumatic device identifier from the pneumatic device identifier field 544 of the aggregator device cycle count message 540. For example, in some embodiments, pneumatic device threshold records including a pneumatic device threshold record 820 as shown in FIG. 17, may have previously been provided and/or generated and may be stored in the location 642 of the storage memory 604.

Referring to FIG. 17, the pneumatic device threshold record 820 may include a pneumatic device identifier field 822 and one or more threshold identifiers and associated threshold values for the pneumatic device 12. Referring to FIG. 17, the pneumatic device threshold record 820 includes a first threshold identifier field 824 for storing a first threshold identifier, and a first threshold value field 826 for storing the first threshold cycle count associated with the first threshold identifier. In various embodiments, the first threshold may be an end of life cycle count threshold representing a cycle count at which the pneumatic device 12 is expected to fail.

In various embodiments, the pneumatic device threshold record 820 may include additional or alternative thresholds defined by respective threshold identifiers and threshold cycle count values. For example, referring to FIG. 17, in various embodiments, the pneumatic device threshold record 820 may include a second threshold identifier field 828 and associated second threshold value field 830 for storing a threshold cycle count at which it is recommended that the pneumatic device 12 be replaced in advance of failure.

Referring to FIG. 17, in various embodiments, the pneumatic device threshold record 820 may include a third threshold identifier field 832 and associated third threshold value field 834 for storing a threshold cycle count at which it is recommended that the pneumatic device 12 be next serviced.

In various embodiments, the threshold identifiers and associated threshold values may have been previously provided when the pneumatic device 12 and/or the counter 14 was first installed or may have been generated by the analyzer 30. For example, in some embodiments, the end of life cycle count threshold value may have been provided by an operator of the pneumatic device 12 via the operator device 38, for example, when registering the pneumatic device 12 with the analyzer 30. In some embodiments, the value for the end of life cycle count stored in the first threshold value field 826 value may have been taken from a manufacturer's specifications for the pneumatic device 12.

In some embodiments, the analyzer 30 may be configured to determine the replacement threshold cycle count based on the end of life cycle count. For example, in some embodiments, the analyzer 30 may be configured to determine the replacement threshold cycle count as a percentage, such as about 85%, for example, of the end of life cycle count.

In some embodiments, the next service suggested threshold may be updated by the analyzer 30 whenever the analyzer 30 receives a message indicating that a service has been completed. For example, in some embodiments, the next service suggested threshold may be determined by adding a predetermined service cycle count to a device cycle count associated with a particular date when the analyzer 30 receives a message indicating that a service has been completed that date. In some embodiments, for example, the predetermined service cycle count may be stored in the location 642 in association with the pneumatic device identifier. In some embodiments, for example, the predetermined service cycle count may be about 1,000,000 cycles.

Referring back to FIG. 15, in various embodiments, block 743 may direct the analyzer processor 600 to use the pneumatic device identifier from the aggregator device cycle count message 540 and/or the device cycle count record 780 to look up the pneumatic device threshold record 820 shown in FIG. 17 from the location 642 of the storage memory 604. In various embodiments, block 743 may direct the analyzer processor 600 to determine the subject threshold cycle count to be one of the cycle count values stored in the threshold value fields 826, 830, and 834. For example, in some embodiments, block 743 may direct the analyzer processor 600 to determine the subject threshold cycle count to be a lowest one of the threshold cycle counts and so block 743 may direct the analyzer processor 600 to determine the subject threshold cycle count to be the cycle count value stored in the threshold value field 834 of the pneumatic device threshold record 820.

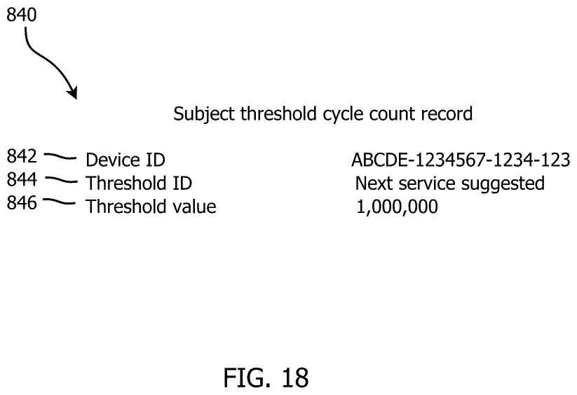

In various embodiments, block 743 may direct the analyzer processor to store the subject threshold cycle count and the associated threshold identifier in a subject threshold cycle count record 840 as shown in FIG. 18 in the location 642 of the storage memory 604 shown in FIG. 14. In various embodiments, the subject threshold cycle count record 840 includes a device identifier field 842, a threshold identifier field 844 and a threshold value field 846. In various embodiments, block 743 may direct the analyzer processor 600 to store the threshold identifier and subject threshold cycle count taken from the pneumatic device threshold record 820 in the threshold identifier field 844 and the threshold value field 846 respectively.

Referring to FIG. 15, block 744 directs the analyzer processor 600 to compare the device cycle count with the subject threshold cycle count to determine whether the device cycle count is greater than the threshold cycle count. In various embodiments, depending on the particular threshold cycle count being considered, the device cycle count being greater than the threshold cycle count may be indicative of various conditions. For example, in some embodiments, the device cycle count being greater than the threshold cycle count may be indicative that the pneumatic device 12 should be serviced and/or replaced now or in the near future. Block 744 may direct the analyzer processor 600 to compare the device cycle count field 784 shown in FIG. 16 to the subject threshold cycle count stored in the threshold value field 846 of the subject threshold cycle count record 840 shown in FIG. 18 to determine whether the device cycle count is greater than the subject threshold cycle count. If at block 744, the analyzer processor 600 determines that the device cycle count is not greater than the subject threshold cycle count then the analyzer processor 600 may do nothing or may be directed to return to block 741 and await reception of another device cycle count for the pneumatic device 12.

Blocks 741, 742, 743, and 744 may thus be executed a plurality of times, such that a plurality of device cycle counts, each associated with the pneumatic device identifier and a respective time, are stored in the location 640 of the storage memory 604. For example, in some embodiments, a device cycle count record having format generally similar to the device cycle count record 780 shown in FIG. 16 may be stored in the location 640 of the storage memory 604 but may include a plurality of device cycle count fields, each storing a cycle count and associated with a respective time field storing a time at which the cycle count was determined. In various embodiments, the resulting device cycle count record stored in the location 640 of the storage memory 604 may represent the device cycle count for the pneumatic device 12 over time.

In various embodiments, using the pneumatic device identifier and determining the threshold cycle count based at least in part on the pneumatic device identifier may facilitate adaptive use of the analyzer 30 with different pneumatic devices and/or may facilitate use of the analyzer 30 with multiple pneumatic devices, keeping count of cycles of all of them.

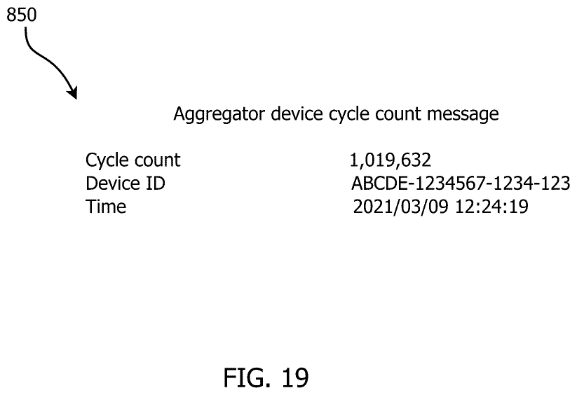

In some embodiments, for example, after some time has passed and numerous aggregator device cycle count messages have been sent by the aggregator 16 and received by the analyzer 30, upon execution of an iteration of blocks 741 and 742, an aggregator device cycle count message 850 as shown in FIG. 19 may be received.

If block 744 is executed after receiving the aggregator device cycle count message 850 shown in FIG. 19, the analyzer processor 600 may determine that the device cycle count is greater than the subject threshold cycle count stored in the threshold value field 846 of the subject threshold cycle count record 840 shown in FIG. 18 and so the analyzer processor 600 may be directed to proceed to block 746.

Referring to FIG. 15, block 746 directs the analyzer processor 600 to, in response to determining that the device cycle count is greater than the threshold cycle count, produce signals for causing a service notification or alert to be displayed to at least one operator of the pneumatic device 12. In various embodiments, the service notification may include contents depending on the threshold that has been surpassed. For example, in some embodiments, the service notification may act as an alert for the operator, to notify the operator that the pneumatic device 12 should be serviced and/or replaced now or in the near future.

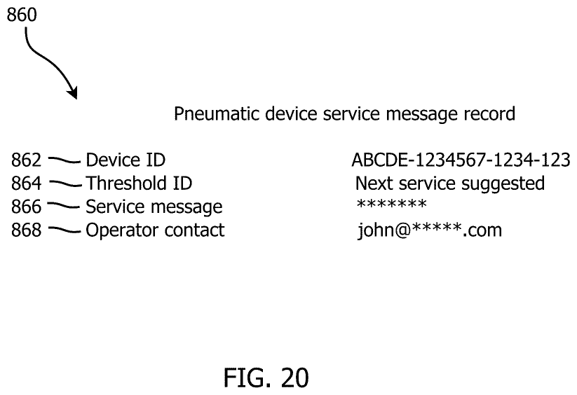

In some embodiments, block 746 may direct the analyzer processor 600 to identify service order information associated with the pneumatic device identifier and the threshold identifier associated with the threshold that was surpassed and to include the service order information in the service notification. For example, in some embodiments, pneumatic device service message records including a pneumatic device service message record 860 as shown in FIG. 20, may have previously been provided and may be stored in the location 644 of the storage memory 604.

Referring to FIG. 20, the pneumatic device service message record 860 includes a pneumatic device identifier field 862 and a threshold identifier field 864 identifying the pneumatic device and associated threshold that the pneumatic device service message record 860 is associated with. The pneumatic device service message record 860 includes a service message field 866 (represented, for ease of reference only, in the drawings with ******) for storing a message to be sent to the operator that may include, for example, replacement information that an operator could use to obtain replacement parts for service of the pneumatic device 12, and an operator contact information field 868 for storing operator contact information. In various embodiments, the replacement information may include a URL for directing the operator to a website at which a replacement part may be ordered, for example. In some embodiments, the operator contact information may include contact information, such as, for example, a phone number, messaging username, email address, or other contact information for an operator of the pneumatic device.

In various embodiments, values for the pneumatic device identifier field 862, threshold identifier field 864, service message field 866, and operator contact information field 868 may have been previously provided when the pneumatic device 12 and/or counter 14 was first installed and/or when an operator registered the pneumatic device 12 with the analyzer 30 upon installation, for example. In some embodiments, these values may have been provided via the operator device 38 shown in FIGS. 1 and 2, for example.

Referring back to FIG. 15, in various embodiments, block 746 may direct the analyzer processor 600 to use the pneumatic device identifier and the threshold identifier from the fields 842 and 844 of the subject threshold cycle count record 840 shown in FIG. 18 to look up the pneumatic device service message record 860 shown in FIG. 20 from the location 644 of the storage memory 604. Block 746 may then direct the analyzer processor 600 to cause a service notification generated based at least in part on the service message field 866 of the pneumatic device service message record 860 to be sent to an operator using the operator contact information stored in the operator contact information field 868. In various embodiments, this may cause the service notification to be displayed to an operator of the pneumatic device 12.

For example in some embodiments, block 746 may direct the analyzer processor 600 to cause an email to be sent to an email address stored in the operator contact information field 868 shown in FIG. 20, the email having the following contents taken from the service message field 866:
Dear operator,
As of 2021 Mar. 9, it's time to service your COM-1000-iSV #1 pneumatic machine (serial number: ABCDE-1234567-1234-123).
Please order service parts on our website using the following link.
Click here to request a quote.
Click here see product details on the website.
Details below—
Total machine cycle count: 1,019,632
Usage before service: 102%
Service required

In various embodiments, a link attached to or included in the email may include a URL taken from the service message field 866 shown in FIG. 20. In various embodiments, after block 746 has been completed, the analyzer processor 600 may be directed to update the pneumatic device threshold record 820 and to return to block 741. In some embodiments, for example, after block 746 has been completed, the analyzer processor 600 may be directed to remove the threshold identifier and threshold value fields associated with the subject threshold cycle count record and return to block 741. In some embodiments, blocks 743 and 744 may be executed for one or more further threshold cycle counts.

In various embodiments, once a service has been completed, an operator may use the operator device 38 to send a message to the analyzer 30 indicating that the service has been completed on a serviced date and the analyzer 30 may update the pneumatic device threshold record 820 to include a new next service suggested threshold, which may have a threshold cycle count value set to a predetermined additional cycles added to the cycle count on or nearest to the serviced date, as reflected in the device cycle count record stored in the location 640 of the storage memory 604 shown in FIG. 14.

In various embodiments, the analyzer 30 may be configured to perform alternative or additional pneumatic device use monitoring functions. For example, in some embodiments, the analyzer 30 may be configured to predict a date or time when the device cycle count will approach or exceed a milestone or threshold cycle count and cause a representation of that predicted date to be displayed to an operator.

In some embodiments, the milestone may be related to servicing of the pneumatic device and the predicted date may be presented to the operator as a suggested service date. In some embodiments, the suggested service date may be chosen from candidate service dates, upon which service of the pneumatic device 12 is preferred. For example, the suggested service date may be chosen based on its proximity to a date on which the cycle count is expected to exceed the threshold cycle count. In various embodiments, causing candidate service dates to be displayed to an operator as suggested service dates may facilitate planning and preparing for servicing or replacement of the pneumatic device on such dates.

In various embodiments, using candidate service dates may facilitate more helpful suggestions for planning a next upcoming service for the pneumatic device 12. In various embodiments, scheduling services on candidate service dates, which are preferred by the operator, may facilitate improved efficiency of the system 10 shown in FIG. 1, such that any negative impact of the service on the functioning of the system 10 is minimized.

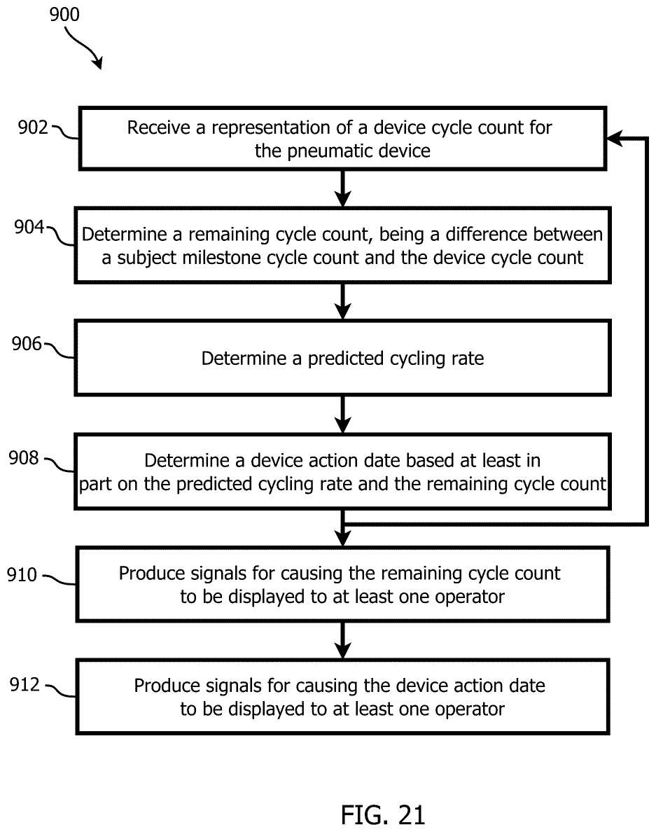

Referring to FIG. 21, a flowchart depicting blocks of code for directing the analyzer processor 600 shown in FIG. 14 to perform pneumatic device use monitoring functions in accordance with various embodiments is shown generally at 900. The blocks of code included in the flowchart 900 may be encoded in the block of codes 670 of the program memory 602 shown in FIG. 14, for example.

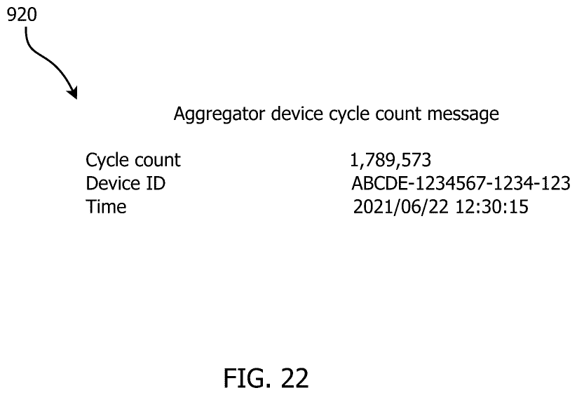

Referring to FIG. 21, the flowchart 900 begins with block 902 which directs the analyzer processor 600 to receive a representation of a device cycle count for the pneumatic device 12. In some embodiments, block 902 may be considered executed through execution of blocks 741 and 742 of the flowchart 740 shown in FIG. 15 and thus if the flowchart 740 is executed, execution of block 902 may be omitted and the analyzer processor 600 may be directed to begin the flowchart 900 at block 904 after execution of blocks 741 and 742. In various embodiments, block 902 may include code generally similar to that included in blocks 741 and/or 742 of the flowchart 740 shown in FIG. 15. In various embodiments, an aggregator device cycle count message 920 as shown in FIG. 22 may be received during execution of block 902 of the flowchart 900, for example.

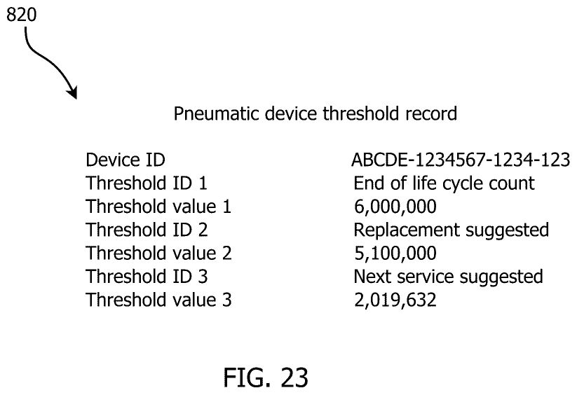

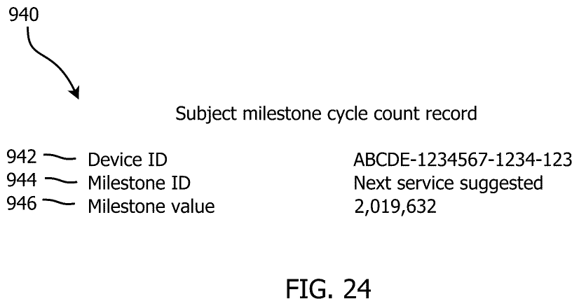

Referring to FIG. 21, block 904 directs the analyzer processor 600 to determine a remaining cycle count, the remaining cycle count being a difference between a subject milestone cycle count and the device cycle count. In some embodiments, one or more of the threshold cycle counts may be used as milestone cycle counts since threshold cycle counts may act as milestones at which an action is expected or suggested with respect to the pneumatic device 12. For example, in some embodiments, a first execution of block 904 may direct the analyzer processor 600 to use the pneumatic device identifier from the received aggregator device cycle count message 850 to look up the pneumatic device threshold record 820, which may have been updated to have the contents as shown in FIG. 23, from the location 642 of the storage memory 604 shown in FIG. 14 and to determine the subject milestone cycle count to be the threshold cycle count associated with the threshold identifier of “Next service suggested”. In various embodiments, block 904 may direct the analyzer processor 600 to generate and store a subject milestone cycle count record 940 as shown in FIG. 24 in the location 646 of the storage memory 604 shown in FIG. 14.

Referring to FIG. 24, the milestone cycle count record 940 includes a device identifier field 942, a milestone identifier field 944, and a milestone cycle count value field 946.

In some embodiments, block 904 may direct the analyzer processor 600 to subtract the device cycle count of the most recently received aggregator device cycle count message 920, shown in FIG. 22, from the milestone cycle count stored in the milestone cycle count value field 946 of the subject milestone cycle count record 940 shown in FIG. 24 to determine the remaining cycle count.

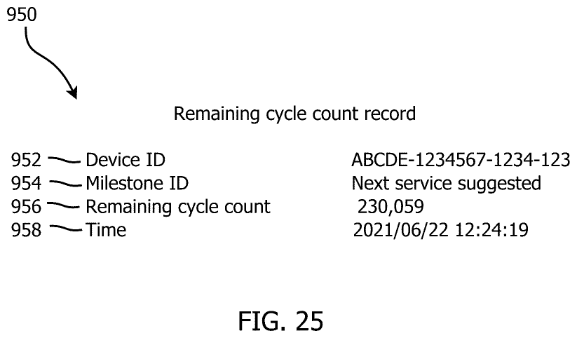

In some embodiments, block 904 may direct the analyzer processor 600 to store the determined remaining cycle count in the location 647 of the storage memory 604. For example, in some embodiments, block 904 may direct the analyzer processor 600 to generate and store a remaining cycle count record 950 as shown in FIG. 25 in the location 647 of the storage memory 604. Referring to FIG. 25, the remaining cycle count record 950 includes a pneumatic device identifier field 952, a milestone identifier field 954, a remaining cycle count field 956, and a time field 958. In various embodiments, block 904 may direct the analyzer processor 600 to use the pneumatic device identifier and the milestone identifier and from the subject milestone cycle count record 940 to populate the pneumatic device identifier field 952 and the milestone identifier field 954 respectively. In various embodiments, block 904 may direct the analyzer processor 600 to use the time from the received aggregator device cycle count message to populate the time field 958 shown in FIG. 25. In various embodiments, block 904 may direct the analyzer processor 600 to store the determined remaining cycle count in the remaining cycle count field 956.

In various embodiments, the flowchart 900 may include blocks 906 and 908 which direct the analyzer processor 600 to determine a device action date. In some embodiments, the device action date may be a date on or near which it is predicted that the cycle count will reach a milestone or threshold cycle count and on which action is suggested or an event is expected. For example, in some embodiments, the device action date may be a suggested device service date on or around a date when it is predicted that the device cycle count will surpass the milestone cycle count from the milestone cycle count value field 946 of the milestone cycle count record 940 shown in FIG. 24.

In some embodiments, other milestones may be used, such that the device action date may indicate an alternative or additional action or event is expected. For example, in some embodiments the milestone may be a predicted device failure date, which may correspond to a date when it is predicted that the cycle count for the pneumatic device will reach its predicted end of life cycle count, for example.

Referring to FIG. 21, block 906 directs the analyzer processor 600 to determine a predicted cycling rate, the predicted cycling rate representing a predicted number of cycles that the pneumatic device will be used for during a future time period. In some embodiments, block 902 of the flowchart 900 shown in FIG. 21 may have been executed numerous times such that a plurality of device cycle counts, each associated with a different time, are stored in the location 640 of the storage memory 604. Accordingly, in various embodiments multiple executions of block 902 may collectively direct the analyzer processor 600 to receive representations of device cycle counts over time. In various embodiments block 906 may direct the analyzer processor 600 to determine the predicted cycling rate based on the device cycle counts over time.

For example, in some embodiments, block 906 may direct the analyzer processor 600 to determine an exponential moving average of the device cycle counts over time, as represented by the plurality of device cycle counts each associated with a different time stored in the location 640 of the storage memory 604, and to determine the predicted cycling rate based at least in part on the exponential moving average.

In various embodiments, block 906 may direct the analyzer processor 600 to determine the exponential moving average of the device cycle counts over time using the device cycle counts and associated times. In some embodiments, for example, block 906 may direct the analyzer processor 600 to apply an exponential moving average (EMA) algorithm, which may act as a low pass filter to smooth a noisy signal of cycle counts over time. In various embodiments, the EMA algorithm may be a recursive algorithm which allows more weight to be put on a most recent data point (depending on the weight coefficient) and less weight on past data. In various embodiments, EMA may facilitate tracking of data from an initial data point. In various embodiments, block 906 may direct the analyzer processor 600 to use the following equation:

$${x}_{EMA} [ t ] = x [ t ] * {k}_{EMA} + {x}_{EMA} [ t - 1 ] * ( 1 - {k}_{EMA} )$$

Where x is a raw signal.
Where X_{EMA} is a smoothed signal.
Where

$${k}_{EMA} = \frac{2}{{T}_{EMA} - 1}$$

is an EMA weight coefficient.
Where T_{EMA}=const is an EMA period, which is a smoothing coefficient equivalent of smoothing across the specified number time divisions.

In various embodiments, time steps of 1 week may be used, and the variable for which the EMA is taken may be a device cycle count per week, m. In various embodiments, a cycle count for any week may be determined from the cycle counts and time data stored in the location 640 of the storage memory 604.

In various embodiments, block 906 may direct the analyzer processor 600 to determine the predicted cycling rate in cycle counts per week using the following equation:

$${m}_{EMA} [ t ] = m [ t ] * {k}_{EMA} + {m}_{EMA} [ t - 1 ] * ( 1 - {k}_{EMA} )$$

Where m_{EMA}[t] is the predicted cycling rate, m[t] is the cycling rate of the most recent week, M_{EMA}[t−1] is the predicted cycling rate that was predicted for the previous week, and

$${k}_{EMA} = \frac{2}{{T}_{EMA} - 1}$$

is an EMA weight coefficient.

In various embodiments EMA may be used to filter the high frequency components of the data set while giving more weight to the most recent data points. In various embodiments, EMA may be more reactive to the latest value change than Simple Moving Average (SMA). In various embodiments, EMA due to its recursive nature may take into account values of all data points from the beginning. In various embodiments, when the pattern of the data set changes, it may be desirable to be able to react and establish the new trend fast enough. In various embodiments, using the EMA (which is a subset of a low pass filter) or another low pass filter may facilitate avoiding or reducing instances where the predicted dates change significantly and may facilitate consistency in the projected data.

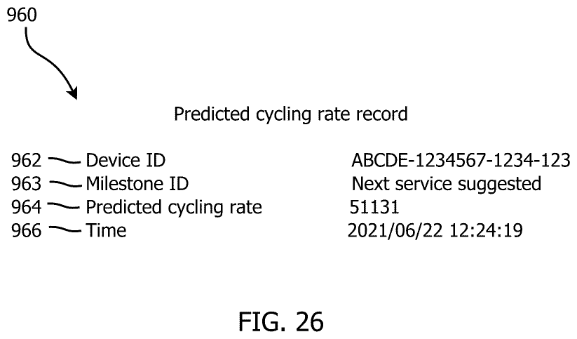

In various embodiments, block 906 may direct the analyzer processor 600 to store the predicted cycling rate in the location 648 of the storage memory 604 shown in FIG. 14. For example, in some embodiments, block 906 may direct the analyzer processor 600 to store a predicted cycling rate record 960 as shown in FIG. 26 in the location 648 of the storage memory 604. Referring to FIG. 26, the predicted cycling rate record 960 includes a pneumatic device identifier field 962, a milestone identifier field 963, a predicted cycling rate field 964 for storing a predicted number of cycles for a future week, and a time field 966 for storing the time associated with the most recent cycling count from which the predicted cycling rate record was determined.

Referring to FIG. 21, block 908 then directs the analyzer processor 600 to determine a device action date based at least in part on the predicted cycling rate and the remaining cycle count. In some embodiments, the device action date may be determined as a date on which it is predicted that the device cycle count will reach the milestone cycle count. In some embodiments, the device action date may be another date near the date on which it is predicted that the device cycle count will reach the milestone cycle count. For example, in some embodiments, the operator, via the operator device 38, for example, may have previously provided the analyzer 30 with a list of candidate service dates, upon which service of the pneumatic device 12 is preferred. For example, in some embodiments, the candidate service dates may be dates during which the factory including the pneumatic device is not running and so servicing of the pneumatic device is possible. In some embodiments, the candidate service dates may include dates that are in advance of an expected busy time for the system 10 and so it may be preferable to have the pneumatic device 12 serviced on the candidate service date to reduce the chances of a failure during the busy or important time. For example, in some embodiments, candidate service dates may include dates in advance of seasonal holidays such as Christmas, Thanksgiving, and Easter to make sure the parts required are in stock and machines are fully serviced and maintained before such holidays to reduce the probability of equipment downtime during the peak production on the holidays. For example, some candidate service dates in 2022 may include:
Sep. 30, 2022—Service 10 days before Thanksgiving (Oct. 10, 2022)
Dec. 15, 2022—Service 10 days before Christmas (Dec. 25, 2022)
Apr. 7, 2022—Service 10 days before Easter (Apr. 17, 2022)
Jan. 1, 2023—Plant shutdown date

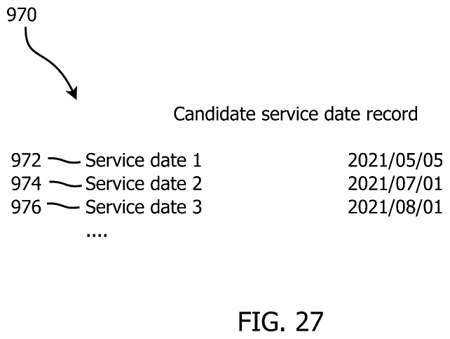

In various embodiments, the candidate service dates may be stored in a candidate service date record 970 as shown in FIG. 27 in the location 650 of the storage memory 604. The candidate service date record 970 may have been received from the operator device 38 during setup of the system 10 shown in FIGS. 1 and 2. The candidate service date record 970 includes candidate service date fields including the fields 972, 974, and 976, for example, identifying candidate service dates upon which service of the pneumatic device 12 is preferred.

In some embodiments, block 908 may direct the analyzer processor 600 to use the following equation to determine an ideal service date:

$${t}_{action} = \frac{{c}_{remaining}}{m} + {t}_{0}$$

Where t_{action} is the ideal service date, upon which it is predicted that the device cycles will reach the milestone cycle count, c_{remaining} is the remaining cycle count, m is the predicted cycling rate, and to is the date of the most recently received cycle count upon which the cycling rate was determined, which may in some embodiments be a current date.

In various embodiments, block 908 may direct the analyzer processor 600 to select a suggested service date from the candidate service dates based at least in part on proximity to the ideal service date. For example, in some embodiments, block 908 may direct the analyzer processor 600 to select the suggested service date as the candidate service date from the candidate service date record 970 stored in the location 650 of the storage memory 604 that is closest to the determined ideal service date.

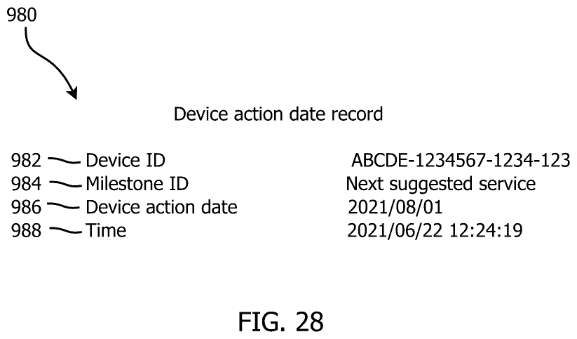

In various embodiments, block 908 may direct the analyzer processor 600 to store the suggested service date as the device action date in memory. For example, in some embodiments, block 908 may direct the analyzer processor 600 to store a device action date record 980 as shown in FIG. 28 in the location 652 of the storage memory 604. Referring to FIG. 28, the device action date record 980 includes a pneumatic device identifier field 982, a milestone identifier field 984, a device action date field 986 for storing the suggested service date as determined at block 908, and a time field 988 for storing the time associated with the most recent cycling count from which the device action date was determined.

Referring to FIG. 21, in various embodiments, after block 908 is executed, the analyzer processor 600 may be directed to re-execute blocks 904 and 908 for one or more additional milestones. In some embodiments, for example, blocks 904 and 908 may be executed to generate a plurality of device action date records, each including a different milestone identifier and thus associated with a different device action. For example, in some embodiments, each of the thresholds included in the pneumatic device threshold record 820 shown in FIG. 23 may be used to generate a device action date record generally similar in format to the device action date record 980 shown in FIG. 28.

In some embodiments, block 908 may direct the analyzer processor 600 to determine the device action date for some milestones, such as, for example, the end of life cycle count, to be the date upon which it is predicted that the device cycles will reach the milestone cycle count, and not chosen from the candidate service dates.

In various embodiments, after block 908, the analyzer processor 600 may be directed return to block 902 and await reception of another aggregator device cycle count message. Accordingly, in various embodiments, blocks 902-908 may be repeated a plurality of times such that the remaining cycle count record 950, predicted cycling rate record 960 and device action date record 980 shown in FIGS. 25, 26, and 28 are kept up to date with each received aggregator device cycle count message.

In some embodiments, an event may trigger execution of blocks 910 and/or 912, to cause pneumatic device status information to be displayed by the operator device 38 shown in FIGS. 1 and 2 to an operator of the pneumatic device 12. For example, in some embodiments, the operator may use the operator device 38 to send a status request message to the analyzer 30 via the network 32 shown in FIGS. 1 and 2. The status request message may include a pneumatic device identifier, for example. In various embodiments, reception of the status request message may trigger execution of blocks 910 and/or 912.

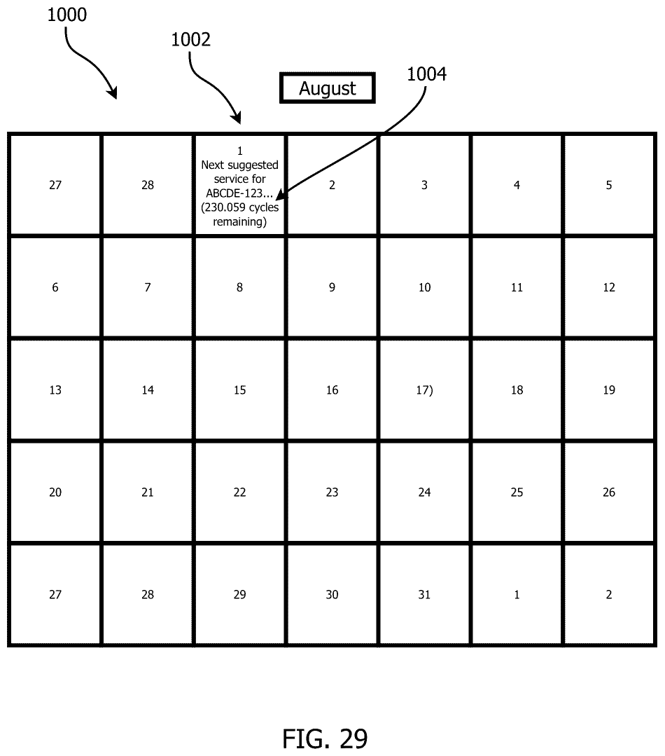

Referring to FIG. 21, block 910 directs the analyzer processor 600 to produce signals for causing a representation of the remaining cycle count to be displayed to at least one operator and block 912 directs the analyzer processor 600 to produce signals for causing a representation of the device action date to be displayed to at least one operator. In some embodiments, blocks 910 and 912 may be combined in a single block directing the analyzer processor 600 to produce signals for causing a user interface or display 1000 as shown in FIG. 29 to be displayed by the operator device 38 to the operator. In various embodiments, the user interface 1000 may include a calendar representation including a representation 1002 of the device action date taken from the device action date record 980 shown in FIG. 28 and a representation 1004 of the remaining cycle count taken from the remaining cycle count record 950 shown in FIG. 25.

In various embodiments, blocks 910 and 912 may direct the analyzer processor 600 to send respective representations of the remaining cycle count record 950 and the device action date record 980 as shown in FIGS. 25 and 28 to the operator device 38 via the network 32 shown in FIGS. 1 and 2 and the operator device 38 may be configured to display the user interface 1000 shown in FIG. 29 to the operator. In various embodiments, the user interface 1000 including a calendar may facilitate ease of reference by an operator to view upcoming milestones and/or suggested service dates. In some embodiments, one of block 910 or 912 may be omitted and only the remaining cycle count or the device action date may be displayed.

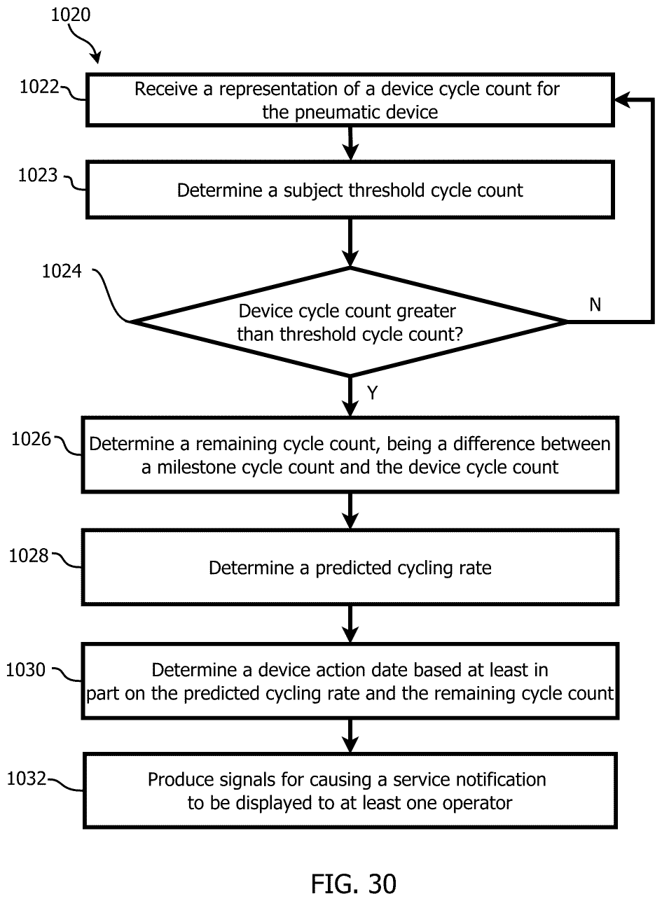

In some embodiments, various functionality of the analyzer 30 described herein may be combined. In some embodiments, functionality from the flowchart 900 shown in FIG. 21 may be incorporated with functionality of the flowchart 740 shown in FIG. 15. For example, in some embodiments, a flowchart 1020 as shown in FIG. 30 may be encoded in the block of codes 670 of the program memory 602 shown in FIG. 14. In various embodiments, the flowchart 1020 may begin with blocks 1022, 1023 and 1024, which may include code generally similar to that included in blocks 741-744 of the flowchart 740 shown in FIG. 15. If at block 1024 it is determined that a device cycle count is greater than a subject threshold cycle count, then a service notification message may be sent to the operator. In various embodiments, predicted device action dates and remaining cycle counts may be incorporated into the content of the service notification message and so blocks 1026, 1028, and 1030 may be executed for one or more milestones, which may be generally similar to blocks 904, 906, and 908 of the flowchart 900 shown in FIG. 21. Referring to FIG. 30, in various embodiments, the flowchart 1020 may include a block 1032 which may direct the analyzer processor 600 to produce signals for causing a service notification to be displayed to at least one operator

In some embodiments, block 1032 may include some code generally similar to that included in the block 746 of the flowchart 740 shown in FIG. 15. However, in various embodiments, block 1032 may direct the analyzer processor 600 to include a remaining cycle count and/or a device action date, as determined at blocks 1026 and 1030 of the flowchart 1020 shown in FIG. 30, in the service notification displayed to the operator. For example, in some embodiments, block 1032 may direct the analyzer processor 600 to cause an email to be sent to an operator of the pneumatic device 12 with the following contents, for example:
Dear operator, as of 2022 Jun. 21, your cylinder has reached 85% of rated cycles with 894,901 cycles remaining. It's time to order a replacement on our website by clicking here.
The cylinder is projected to hit the rated 6,000,000 cycles on 2022 Sep. 27.
Cylinder Life: 85%
5,104,099/6,000,000 cycles

In various embodiments, the link attached to or included in the email may include a URL taken from a replacement information field associated with the threshold that was exceeded at block 1024. In various embodiments, block 1032 may direct the analyzer processor 600 to include data from a remaining cycle count record generated at block 1026 and a device action date record generated at block 1030 in the body of the email.

### Partial Device Cycle Count Operation

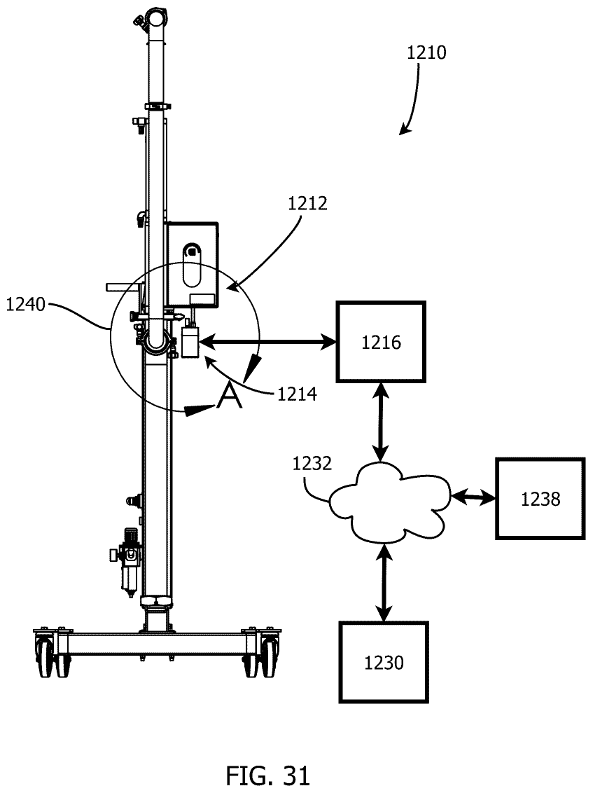

Referring now to FIG. 31, there is shown a system 1210 for monitoring use of a pneumatic device 1212, in accordance with various embodiments. In various embodiments, the system 1210 may include a counter 1214, an aggregator 1216, an analyzer 1230 and an operator device 1238, which may be configured to function generally similar to the counter 14, aggregator 16, analyzer 30, and operator device 38 shown in FIGS. 1 and 2 and described herein. In various embodiments, the pneumatic device 1212 shown in FIG. 31 may have already been operating for an uncounted operating time period prior to installation of the counter 1214 on the device 1212. Accordingly, device cycle counts tracked by the counter 1214 after installation may not provide a complete understanding of total device cycle counts performed by the device 1212.

In various embodiments, the analyzer 1230 may be configured to determine an estimated aggregate cycle count over the life of the pneumatic device 1212, including an estimated device cycle count over the uncounted time period. In various embodiments, the determined estimated aggregate cycle count may be stored and treated generally as described herein regarding the device cycle count and FIGS. 1-30. In various embodiments, determining the estimated aggregate cycle count may facilitate installation of the counter 1214 and use of the system 1210 with a device such as the pneumatic device 1212, which has not had the counter 1214 counting cycles from the beginning of operation of the pneumatic device 1212. In various embodiments, this may enable retrofitting of the system 1210 with various pneumatic devices, which may enable cost savings and improved monitoring of the system 1210 despite previous use of the pneumatic device 1212.

In various embodiments, the counter 1214 and the aggregator 1216 may function generally similarly to the counter 14 and aggregator 16 as described above with reference to FIGS. 1 and 2. In various embodiments, the aggregator 1216 may send to the analyzer 1230, aggregator device cycle count messages over time, the aggregator device cycle count messages including device cycle counts that represent counts of cycles performed by the pneumatic device 1212 since the counter 1214 was installed on the pneumatic device 1212.

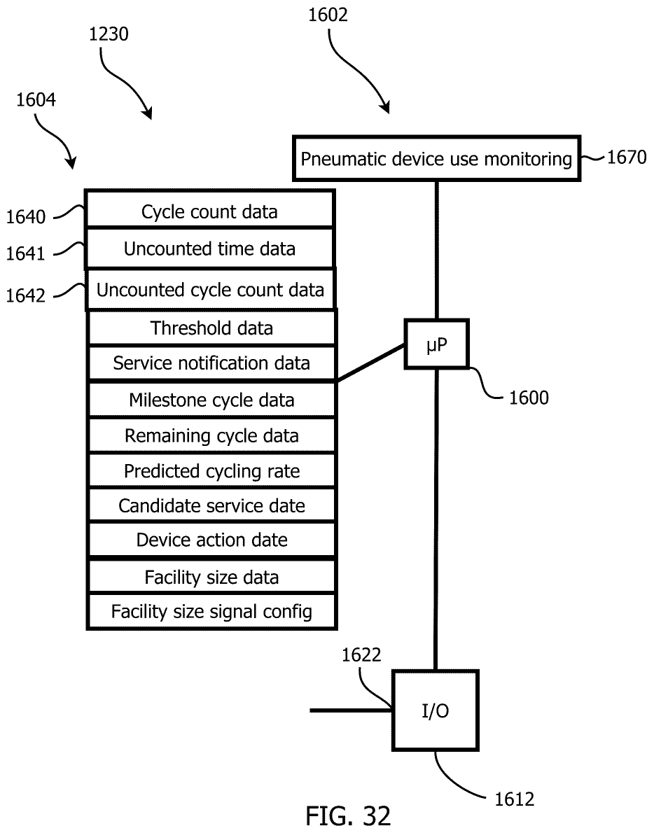

Referring to FIG. 32, there is shown a schematic view of the analyzer 1230 shown in FIG. 31 according to various embodiments. In various embodiments, the analyzer 1230 may include elements generally similar to the elements included in the analyzer 30 shown in FIG. 14. Referring to FIG. 32, the analyzer 30 includes a processor circuit including an analyzer processor 1600 and a program memory 1602, a storage memory 1604, and an input/output (I/O) interface 1612, all of which are in communication with the analyzer processor 1600.

The I/O interface 1612 includes an interface 1622 for communicating with the network 1232 shown in FIG. 31. In some embodiments, the interface 1622 may facilitate communication with the aggregator 1216 via the network 1232.

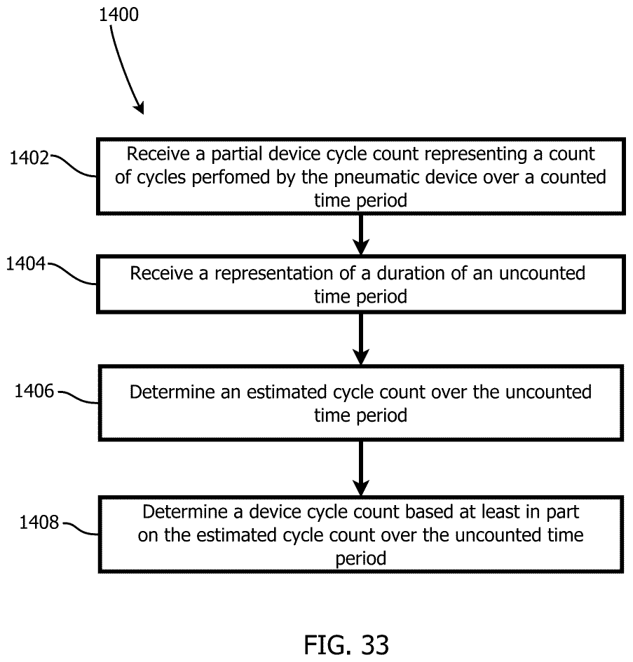

Referring to FIG. 33, a flowchart 1400 depicting blocks of code for directing the analyzer processor 1600 shown in FIG. 32 to perform pneumatic device use monitoring functions in accordance with various embodiments is shown. The blocks of code included in the flowchart 1400 may be encoded in block of codes 1670 of the program memory 1602 shown in FIG. 32, for example.

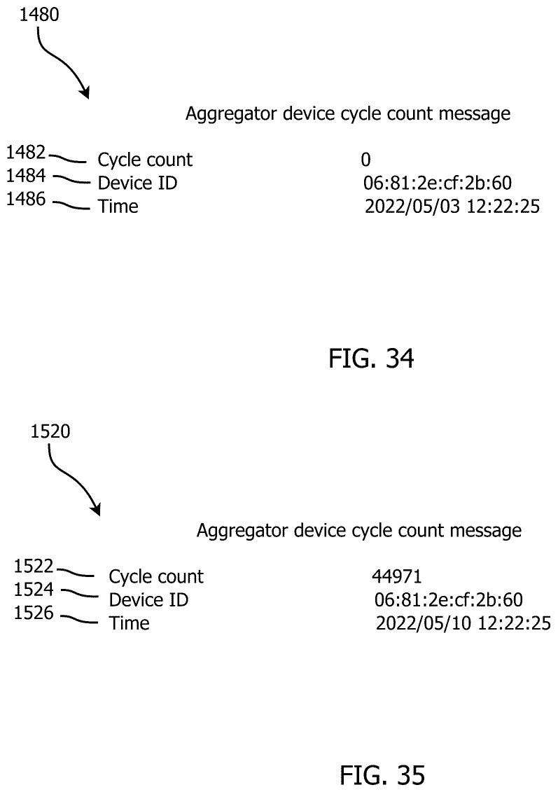

Referring to FIG. 32, the flowchart 1400 begins with block 1402, which directs the analyzer processor 1600 to receive a partial device cycle count for the pneumatic device 1212 representing a count of cycles performed by the pneumatic device 1212 over a counted operating time period. In various embodiments, block 1402 may direct the analyzer processor 1600 to receive a first aggregator device cycle count message 1480 as shown in FIG. 34 from the aggregator 1216 shown in FIG. 31 via the network 1232 and to later receive further aggregator device cycle count messages including a subsequent aggregator device cycle count message 1520 as shown in FIG. 35 from the aggregator 1216 shown in FIG. 31 via the network 1232.

In various embodiments, the aggregator device cycle count messages 1480 and 1520 may include device cycle count fields 1482 and 1522, respectively, for storing respective counts of device cycle counts that have been sensed by the counter 1214. In various embodiments, the aggregator device cycle count messages 1480 and 1520 may include pneumatic device identifier fields 1484 and 1524 respectively for identifying the pneumatic device 1212. In various embodiments, the aggregator device cycle count messages 1480 and 1520 may include time fields 1486 and 1488 for storing respective times at which the respective device cycle counts were determined. In various embodiments, the received aggregator device cycle count messages including the messages 1480 and 1520 or a representation thereof (such as, for example, a device cycle count record including a pneumatic device identifier field, device cycle count fields and associated times) may be stored in the location 1640 of the storage memory 1604.

In some embodiments, a counted time period and a partial device cycle count associated with the counted time period may be determined from the messages 1480 and 1520. For example, in some embodiments, a partial device cycle count determined as the difference between device cycle counts from the device cycle count fields 1522 and 1482 may be associated with a counted operating time period being the difference between the times in the time fields 1526 and 1486. In various embodiments, the uncounted operating time period may precede the counted operating time period.

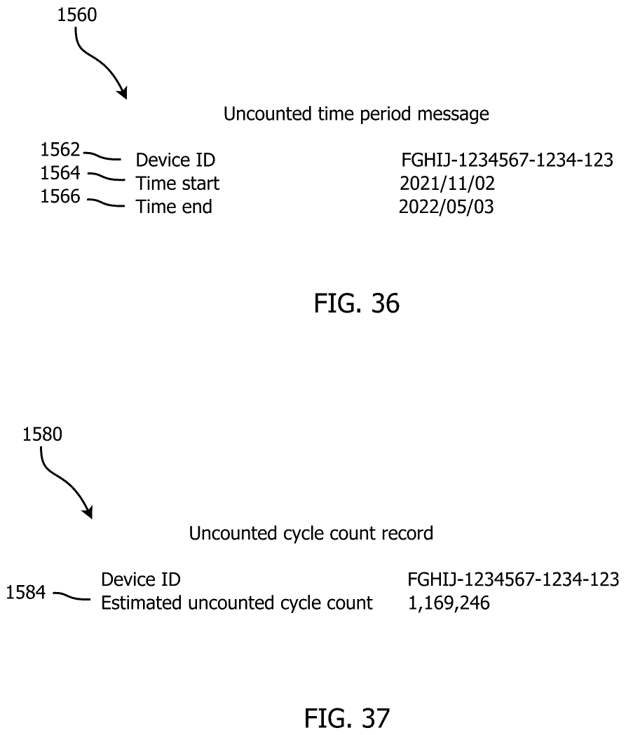

Referring to FIG. 33, block 1404 directs the analyzer processor 1600 to receive a representation of a duration of an uncounted operating time period. In some embodiments, block 1404 may have occurred prior to execution of block 1402, such as, for example, during setup of the analyzer 1230. For example, in some embodiments, the uncounted operating time period may be provided by the operator via the operator device 1238 shown in FIG. 31 during initialization or set up of the analyzer 1230. In some embodiments, block 1404 may direct the analyzer processor 1600 to receive an uncounted time period message 1560 as shown in FIG. 36 from the operator device 1238 via the network 1232 shown in FIG. 31. Referring to FIG. 36, in various embodiments, the uncounted time period message 1560 may include a pneumatic device identifier field 1562, a time start field 1564 for storing a starting time or date of the uncounted time period, and a time end field 1566 for storing an end time or date of the uncounted time period. In various embodiments, the values included in the time start field 1566 and the time end field 1568 may have been provided by an operator of the pneumatic device 1212 shown in FIG. 31. In some embodiments, the machine serial number string acting as a pneumatic device identifier “FGHIJ-1234567-1234-123” may be associated with the MAC address acting as a pneumatic device identifier, “06:81:2e:cf:2b:60” in the storage memory 1604. In various embodiments, the values included in the time start field 1564 and the time end field 1566 may represent a length of time during which the device 1212 had previously operated before the counter 1214 was installed. In various embodiments, a representation of the uncounted time period message 1560 may be stored in the location 1641 of the storage memory 1604 shown in FIG. 32.

Referring to FIG. 33, block 1406 then directs the analyzer processor 1600 to determine an estimated cycle count over the uncounted time period based at least in part on the partial device cycle count, a duration of the counted operating time period, and the duration of the uncounted operating time period.

In various embodiments, block 1406 may direct the analyzer processor 1600 to determine an estimated cycling rate during the uncounted time period and to multiply the estimated cycling rate by the duration of the uncounted operating time period. In various embodiments, block 1406 may direct the analyzer processor 1600 to determine the estimated number of cycles performed by the pneumatic device 1212 over the uncounted time period to be the result of the multiplication.

In some embodiments, block 1406 may direct the analyzer processor 1600 to determine the estimated cycling rate as equal to a cycling rate determined for the counted time period. In some embodiments, block 1406 may direct the analyzer processor 1600 to determine the cycling rate for the counted time period by determining a ratio between the partial device cycle count and a duration of the counted operating time period. In some embodiments, using the cycling rate for the counted time period as an estimate of the cycling rate for the uncounted period may facilitate an accurate and easily determinable estimation of cycling rate for the uncounted period. In some embodiments, this may facilitate a reduction of input required from an operator of the pneumatic device 12, in order to determine the estimated cycling rate for the uncounted time period.

For example, in various embodiments, block 1406 may direct the analyzer processor 1600 to determine the cycling rate for the counted time period as equal to the difference between the device cycle count stored in the field 1522 of the most recently received aggregator device cycle count message 1520 shown in FIG. 35 and the device cycle count stored in the field 1482 of the previously received aggregator device cycle count message 1480 shown in FIG. 34 divided by the difference between the time stored in the time field 1526 of the most recently received aggregator device cycle count message 1520 shown in FIG. 35 and the time stored in the time field 1486 of the previously received aggregator device cycle count message 1480 shown in FIG. 34.

In various embodiments, block 1406 may direct the analyzer processor 1600 to use the following equation to determine an estimated cycle count over the uncounted time period:

$${N}_{uncounted} = \frac{{N}_{1} - {N}_{0}}{{t}_{1} - {t}_{0}} * {t}_{uncounted}$$

where N_{uncounted} is the estimated cycle count over the uncounted time period, N₀ is the earlier received device cycle count (e.g., device cycle count field 1482 shown in FIG. 34), t₀ is the time associated with the earlier received device cycle count (e.g., time field 1486 shown in FIG. 34), N₁ is the recently received device cycle count (e.g., device cycle count field 1522 shown in FIG. 35), t₁ is the time associated with the earlier received device cycle count (e.g., time field 1526 shown in FIG. 35), and t_{uncounted} is the duration of the uncounted time period stored in the location 1641 of the storage memory 1604.

In various embodiments, block 1406 may direct the analyzer processor 1600 to store the determined estimated cycle count over the uncounted time period in an estimated uncounted cycle count field 1584 of an uncounted cycle count record 1580 as shown in FIG. 37. In some embodiments, the uncounted cycle count record 1580 may be stored in a location 1642 of the storage memory 1604.

Referring back to FIG. 33, the flowchart continues at block 1408 which directs the analyzer processor 1600 to determine a device cycle count or aggregate device cycle count based at least in part on the estimated cycle count over the uncounted time period. In various embodiments, the device cycle count or aggregate device cycle count may represent the cycle count over the uncounted time period and a counted time period starting at the end of the uncounted time period and thus may represent the total device cycle count for the device 1212.

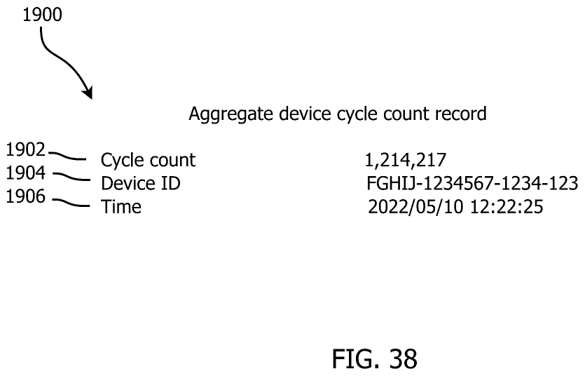

In some embodiments, block 1408 may direct the analyzer processor 1600 to determine the device cycle count by summing the estimated cycle count over the uncounted time period with a partial device cycle count. For example, in some embodiments, block 1408 may direct the analyzer processor 1600 to generate an aggregate device cycle count record 1900 as shown in FIG. 38 wherein the cycle count stored in the cycle count field is determined by summing the estimated uncounted cycle count from the field 1584 of the uncounted cycle count record 1580 shown in FIG. 37 with the cycle count from the cycle count field 1522 shown in FIG. 35. In various embodiments, block 1408 may direct the analyzer processor 1600 to generate a respective aggregate device cycle count record 1900 for each aggregator device cycle count message stored in the location 1640 of the storage memory 1604.

In some embodiments, block 1408 may be incorporated in any block of code described herein where a representation of a device cycle count is received, such that the device cycle count is treated as a partial device cycle count and an aggregate device cycle count is determined by adding the estimated cycle count over the uncounted time period and the aggregate device cycle count is then used as the device cycle count, as described herein. In some embodiments, blocks 1402-1406 may be executed at a calibration time (such as for example about 1 week after installation of the counter 1214) such that the uncounted cycle count record 1580 is stored in the location 1641 of the storage memory 1604 and subsequently each device cycle count that is received from the counter 1214 may be treated as a partial device cycle count and an aggregate device cycle count may be determined for each received aggregator device cycle count message by adding the estimated cycle count over the uncounted time period. In various embodiments, the aggregate device cycle count may then be used as the device cycle count, as described herein, with reference to FIGS. 1-30, for example.

For example, in some embodiments, block of codes 1670 of the analyzer 1230 shown in FIG. 32 may include blocks of codes generally similar to those included in the flowchart 740 shown in FIG. 15 and a block generally similar to the block 742 of the flowchart 740 may direct the analyzer processor 1600 to generate an aggregate device cycle count record by adding the estimated cycle count from the field 1584 of the uncounted cycle count record 1580 shown in FIG. 37 to the cycle count included in each received aggregator device cycle count message. In various embodiments, the cycle counts included in the aggregate device cycle count records may be treated as device cycle counts generally as described herein.

In some embodiments, block of codes 1670 of the analyzer 1230 shown in FIG. 32 may include blocks of codes generally similar to those included in the flowchart 900 shown in FIG. 21 and a block generally similar to the block 902 of the flowchart 900 may direct the analyzer processor 1600 to generate an aggregate device cycle count record by adding the estimated cycle count from the field 1584 of the uncounted cycle count record 1580 shown in FIG. 37 to the cycle count included in each received aggregator device cycle count message. In various embodiments, the cycle counts included in the aggregate device cycle count records may be treated as device cycle counts generally as described herein.

In some embodiments, block of codes 1670 of the analyzer 1230 shown in FIG. 32 may include blocks of codes generally similar to those included in the flowchart 1020 shown in FIG. 30 and a block generally similar to the block 1022 of the flowchart 1020 may direct the analyzer processor 1600 to generate an aggregate device cycle count record by adding the estimated cycle count from the field 1584 of the uncounted cycle count record 1580 shown in FIG. 37 to the cycle count included in each received aggregator device cycle count message. In various embodiments, the cycle counts included in the aggregate device cycle count records may be treated as device cycle counts generally as described herein.

### Various Embodiments

In some embodiments, a pneumatic device identifier used in the system 10 shown in FIGS. 1 and 2 may include information that is associated with or identifies the type or model of the pneumatic device 12. In some embodiments, a pneumatic device threshold record similar to the pneumatic device threshold record 820 including the end of life cycle count threshold and the replacement suggested threshold may be applicable to all pneumatic devices of the same type and so may include a pneumatic device type or model field instead of a pneumatic device identifier field and block 744 of the flowchart 740 shown in FIG. 15, block 904 of the flowchart 900 shown in FIG. 20, and block 1026 of the flowchart 1020 shown in FIG. 24 may each direct the analyzer processor 600 to look up the pneumatic device threshold record 820 based on the pneumatic device type or model field.

In some embodiments, the counter 14 may include and be powered by batteries. In various embodiments, the battery-driven approach may allow collection of operational data from pneumatic machines. In some embodiments, the counter processor 200 may be rated to operate at around 3.3V volts. Connecting two AA batteries (1.5V each) in series may produce the desired voltage (3V). Connecting additional two AA batteries in the same configuration in parallel, may keep the voltage at the same level of (3V), but may double the time of operation on battery. Accordingly, in various embodiments, the counter 14 may include four AA batteries configured to provide 3V. In various embodiments, using a standard battery in the counter 14 may allow the operator to easily replace the battery with one that is obtainable at almost any store when needed. In various embodiments, standard batteries may be cheap compared to a custom special battery. In some embodiments, using low power components may allow the batteries to last for a long term without replacement.

While in various embodiments, block 906 of the flowchart 900 shown in FIG. 21 may direct the analyzer processor 600 to use an EMA as described herein, in some embodiments, block 906 and/or similar blocks may direct the analyzer processor 600 to apply an alternative or additional trend identifying filter to the device cycle count over time to determine the predicted cycling rate. For example, in some embodiments, block 906 of the flowchart 900 may direct the analyzer processor 600 to more generally apply a low pass filter to the device cycle count over time to determine an average rate of change of the device cycle count over a past time period and to determine the predicted cycling rate to be equal to the determined average rate of change.

In various embodiments, using the EMA may establish a current trend based on most recent usage. EMA is calculated through recursion, where it gives more weight to the most recent element. Every element since the inception of the data series is accounted. EMA may be well suited for forecasting because the trend may change entirely, and EMA may facilitate recognition of a new projected date based on a new trend without waiting too long for more data to be accumulated. In various embodiments, using EMA may be computationally light and easy to implement during development.

In various embodiments, a simple moving average may be used to determine the predicted cycling rate. In various embodiments, simple moving average may be a simple form of low pass filter (averaging filter) and may be easy to calculate and give a relatively accurate projection if deviation from the trend is low. In various embodiments, it may take a long time for the SMA filter to adjust if the trend changes too much. In various embodiments, the output from the SMA filter may be calculated by arithmetically adding each of the most recent elements of a series (for example 20 elements) and then dividing that value by that fixed number of elements (for example 20).

In various embodiments, a simple moving average for every component of the data series may be used to determine the predicted cycling rate wherein for every time step along the way, it may be taken into account on an equally weighted basis, each element of the input data series. In some embodiments, this may be good for integrating raw value to do interpolation assuming the trend doesn't change significantly and often.

In some embodiments, singular spectrum analysis may be used to determine the predicted cycling rate. In some embodiments, this may provide an excellent way of forecasting the future based on the past trends and cyclical patterns. In some embodiments, the singular spectrum analysis may decompose the signal into eigenvectors and eigenvalues which may allow decomposing the signal into multiple components of the trend. For example, if there is an exponentially growing signal superimposed with a cyclical oscillation, the algorithm may identify those trend components and make a forecast. In some embodiments, SSA may be good for doing analyses for cyclical features and trends to identify patterns.

While various records have been described as separate herein, in some embodiments, any or all of the records described herein may be combined such that the information from the records are contained in a single record. By way of example, in some embodiments, a single record may be stored in the storage memory 604 of the analyzer 30, which may include information from any or all of the device cycle count record 780 shown in FIG. 16, the pneumatic device threshold record 820 shown in FIG. 17, the pneumatic device service message record 860 shown in FIG. 20, the remaining cycle count record 950 shown in FIG. 25, the predicted cycling rate record 960 shown in FIG. 26, and/or the device action date record 980 shown in FIG. 28.

In some embodiments, functionality from any or all of the counter 14, aggregator 16, analyzer 30, and/or operator device 38 may be combined and/or split up in different ways. For example, in some embodiments, a system which provides functionality generally similar to the system 10 may include a counter generally similar to the counter 14, except that the counter may be configured to store device cycle counts and execute code from any or all of the flowchart 480 shown in FIG. 11, the flowchart 740 shown in FIG. 15, the flowchart 900 shown in FIG. 21, the flowchart 1020 shown in FIG. 30, and/or the flowchart 1400 shown in FIG. 33.

In some embodiments, a system which provides functionality generally similar to the system 10 shown in FIGS. 1 and 2 or a similar system may include a counter generally similar to the counter 14 but configured to communicate directly with an analyzer generally similar to the analyzer 30 shown in FIGS. 1 and 2, without an aggregator acting as an intermediary for the communication. In such embodiments, the analyzer may be configured to perform any or all of the functions described herein as performed by the aggregator 16.

In some embodiments, a counter generally similar to the counter 14 may include an alternative or additional sensor and/or sensor configuration. For example, in some embodiments, the counter may include a sensor configured to sense fluid flow within the pneumatic device 12 and/or fluid flow into the pneumatic device 12 instead of fluid flow from an exhaust of the pneumatic device 12.

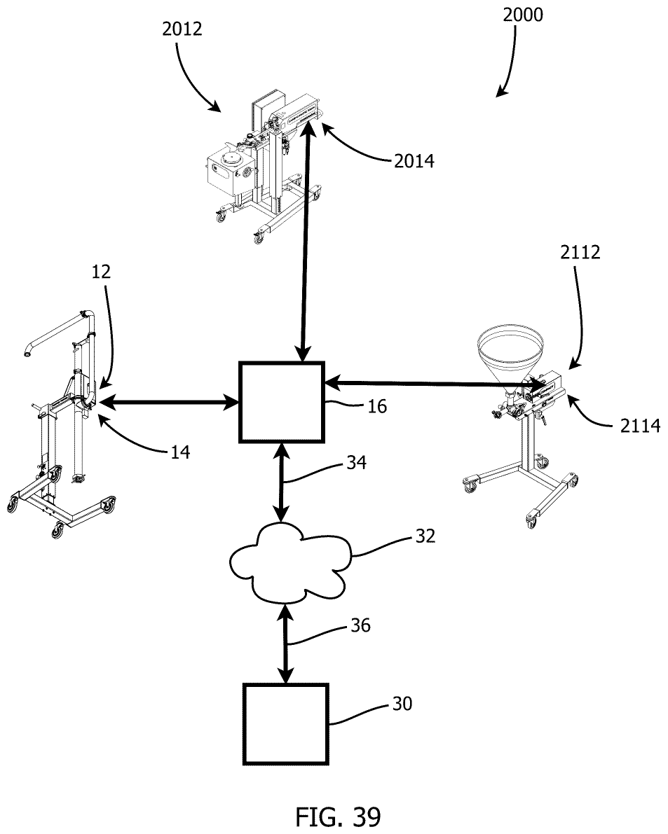

In various embodiments, the analyzer 30 may be configured to monitor use of many different pneumatic devices. For example, in various embodiments, tens, hundreds, or thousands of pneumatic devices and/or aggregators generally similar to the pneumatic device 12 and the aggregator 16 shown in FIGS. 1 and 2 and described herein may be configured to periodically send aggregator device cycle count messages to the analyzer 30 and the analyzer 30 may be configured to treat each message generally as described herein. In various embodiments, each of the aggregator device cycle count messages may include a unique pneumatic device identifier. Referring to FIG. 39, there is shown a system 2000 according to various embodiments that includes the pneumatic device 12, the counter 14, the aggregator 16, the analyzer 30, and the operator device 38. In various embodiments, each may function generally as described herein. In various embodiments, the system 2000 also includes a second pneumatic device 2012, which may be a cake icer, for example, and a counter 2014 installed thereon, and a third pneumatic device 2112, which may be a filling machine, for example, and a counter 2114 installed thereon. In various embodiments, the second and third counters 2014 and 2114 may function generally the same as the counter 14 described herein, but each may use a different unique pneumatic device identifier. In various embodiments, additional, alternative, or fewer pneumatic devices and counters may be included in the system 2000.

In various embodiments, the analyzer 30 may be configured to produce signals for causing a service notification to be displayed to at least one operator of the pneumatic device 12 via alternative or additional means. For example, in some embodiments, the analyzer 30 may be configured to cause the service notification to be sent via email, a messaging application, a text message, specialized app alert, and/or another notification system or software.

In some embodiments, block 404 may direct the counter processor 200 to identify a cyclical feature by alternative or additional analysis of the representation of the sensed fluid signal. For example, in some embodiments, the counter processor 200 may receive a raw sensed fluid signal and block 404 may direct the counter processor 200 to identify a shape or property of the sensed fluid signal that is present once per cycle of the pneumatic device 12.

In various embodiments, block 744 of the flowchart 740 shown in FIG. 15 may direct the analyzer processor 600 to compare various additional or alternative thresholds, such as a end of life cycle count threshold indicative of an end of life of the pneumatic device being expected, or a component specific service or end of life threshold, or another threshold, for example. In various embodiments, different messages may be included in a pneumatic device service message record or alert and associated with each different threshold.

In various embodiments, block 1406 of the flowchart 1400 shown in FIG. 33 may direct the analyzer processor 1600 to use other processes to determine the estimated cycling rate, such as, for example, any or all of the processes described in connection with determining the predicted cycling rate at block 906 of the flowchart 900 shown in FIG. 21.

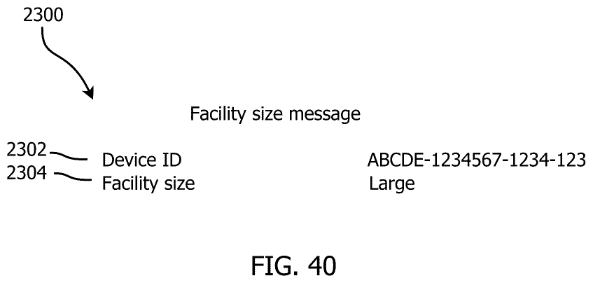

In some embodiments, during setup of the counter 14 shown in FIG. 10, the operator may send to the analyzer 30, an indication of facility size within which the pneumatic device 12 is operating. For example, in some embodiments, the operator may use the operator device 38 to send a facility size message 2300 as shown in FIG. 40 to the analyzer 30. In various embodiments a small facility may be considered as a facility having less than 5,000 sf and a large facility may be considered as a facility having equal to or greater than 5,000 sf, for example. In various embodiments, the facility size may affect how the counter 14 communicates with the aggregator 16. For example, in some embodiments, a small facility size may result in the counter 14 requiring less power for communicating with the aggregator 16. In some embodiments, a small facility size may result in the counter 14 requiring a lower frequency of signal repeating when communicating with the aggregator 16.

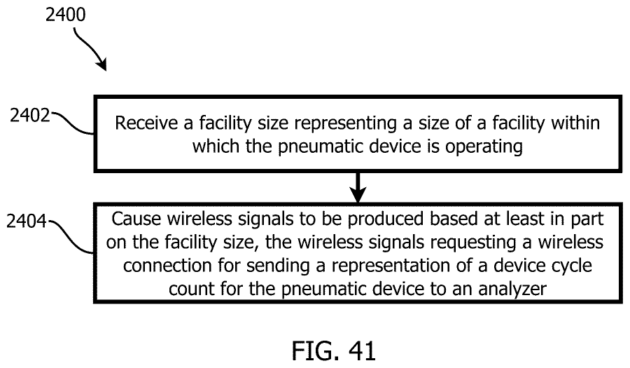

Referring to FIG. 41, a flowchart depicting blocks of code for directing the analyzer processor 600 shown in FIG. 14 to perform pneumatic device use monitoring set up functions in accordance with various embodiments is shown generally at 2400. The blocks of code included in the flowchart 2400 may be encoded in the block of codes 670 of the program memory 602 shown in FIG. 14, for example.

Referring to FIG. 41, the flowchart 2400 begins with block 2402, which directs the analyzer processor 600 to receive a facility size representing a size of a facility within which the pneumatic device is operating. In various embodiments, block 2402 may direct the analyzer processor 600 to receive the facility size message 2300 shown in FIG. 40 from the operator device 38. In some embodiments, the facility size message 2300 may include a pneumatic device identifier field 2302 for storing the pneumatic device identifier identifying the pneumatic device 12 and a facility size field 2304 for storing a facility size representing a size of a facility within which the pneumatic device is operating, as provided by the operator using the operator device 38. In various embodiments, block 2402 may direct the analyzer processor 600 to store the facility size message 2300 in the location 654 of the storage memory 604 shown in FIG. 14.

Block 2404 then directs the analyzer processor 600 to cause wireless signals to be produced based at least in part on the facility size, the wireless signals requesting a wireless connection for sending a representation of a device cycle count for the pneumatic device to an analyzer. In various embodiments, block 2404 may direct the analyzer processor 600 to cause the counter 14 to use particular wireless signal properties when the counter executes block 416 of the flowchart 410 shown in FIG. 9, the wireless signal properties chosen based on the facility size. In various embodiments, depending on the facility size as indicated by the operator, the power and/or signal repeating interval used at block 416 of the flowchart 410 shown in FIG. 9 may be varied. In some embodiments, controlling the signal properties based on the facility size may facilitate efficient use of power in execution of the block 416. In some embodiments, this may facilitate proper functioning of the system 10 while also keeping power use by the counter 14 down when possible.

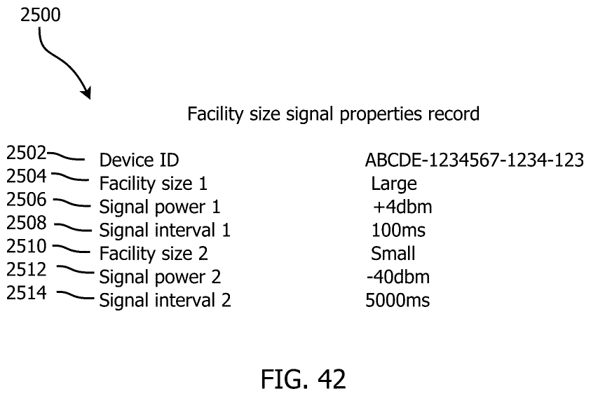

In some embodiments, the facility size may be associated with a signal power and/or the facility size may be associated with a signal repeating interval. For example, in some embodiments, an association between facility sizes and respective signal powers and signal repeating intervals may be stored in the location 656 of the storage memory 604 shown in FIG. 14. For example, in some embodiments, a facility size signal properties record 2500 as shown in FIG. 42 may be stored in the location 656 of the storage memory 604. In various embodiments, the contents of the facility size signal properties record 2500 may have been previously set by a provider of the analyzer 30 and/or counter 14.

Referring to FIG. 42, the facility size signal properties record 2500 includes a pneumatic device identifier field 2502 for storing the pneumatic device identifier identifying the pneumatic device 12. The facility size signal properties record 2500 also includes a first facility size field 2504 and an associated first signal power field 2506 for storing a signal power to be used by the counter 14 at block 416 of the flowchart 410 shown in FIG. 9 when the facility size is as indicated in the first facility size field 2504. The facility size signal properties record 2500 also includes a first signal interval field 2508 associated with the first facility size field 2504 for storing a signal repeating interval to be used by the counter 14 at block 416 of the flowchart 410 shown in FIG. 9. In various embodiments, the facility size signal properties record 2500 may include a second facility size field 2510 and associated second signal power field 2512 and second signal interval field 2514.

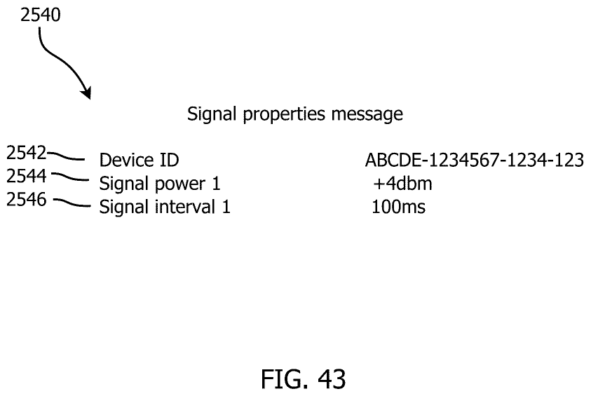

In various embodiments, block 2404 may direct the analyzer processor 600 to look up the signal power and signal repeating interval associated with the facility size from the facility size field 2304 of the facility size message 2300 and generate a signal properties message as shown at 2540 of FIG. 43. Block 2404 may direct the analyzer processor 600 to send the signal properties message 2540 to the counter 14 via the aggregator 16.

In various embodiments, the counter 14 may be configured to receive the signal properties message 2540 and to store a representation of the signal properties message 2540 in the location 250 of the storage memory 204 shown in FIG. 5. In various embodiments, upon execution of block 416 of the flowchart 410, block 416 may direct the counter processor 200 to read the signal power from the field 2544 of the signal properties message 2540 and produce the wireless signals having power set to the signal power.

In various embodiments, block 416 may direct the counter processor 200 to read the signal repeating interval from the field 2546 of the signal properties message 2540 and repeatedly produce the wireless signals requesting the wireless connection at intervals set to the signal repeating interval.

In various embodiments, facilitating automatic adapting of signal power and/or signal repeating interfacial may facilitate efficient, effective, and/or low power usage by the counter 14.

In various embodiments, the analyzer 30 or 1230 described herein and/or any or all functions of the analyzer 30 or 1230 may be used with additional or alternative devices or systems for providing device cycle counts.

In some embodiments, any or all of the cycle count thresholds may be associated with a maximum date threshold representing the maximum date (like expiry date) when a service or replacement has to happen if the cycle count threshold is not hit. For example: it may be recommended to service a filter in an air regulator every three months or 1,920,000 cycles, whichever is sooner. In such embodiments, block 744 of the flowchart 740 shown in FIG. 15 may include codes for directing the analyzer processor 600 to determine whether a current date is greater than a maximum date threshold (e.g., a recommended service date). In some embodiments, block 912 of the flowchart 900 shown in FIG. 21 may direct the analyzer processor 600 to display the maximum date threshold via the user interface 1000.

In some embodiments, an execution of blocks 1032 of the flowchart 1020 shown in FIG. 30 may direct the analyzer processor 600 to cause an email having the following exemplary contents be sent to an operator:
Dear operator,
As of 2022 Nov. 26, it's time to replace your “White Filter in the Air Regulator” on your COM-1000-iSV #1 pneumatic machine (serial number: ABCDE-1234567-1234-123). Service required by: 2022 Dec. 31
Please order replacement on our website in advance using the following link.
Click here to request a quote.
Click here see the product details on the website.
Details below—
Total machine cycle count: 5,100,500
Current Component Usage: 90%
Service required by: 2022 Dec. 31
Based on cycle count:
Remaining Cycle Count: 500,000
Projected end of life date: 2023 Mar. 15
Current Cycle Count: 1,500,000
Percentage: 75%
Based on expiry date:
Last replacement date: 2022 Jan. 3
Maximum expiry date: 2022 Dec. 31
Today: 2022 Nov. 26
Percentage: 90%

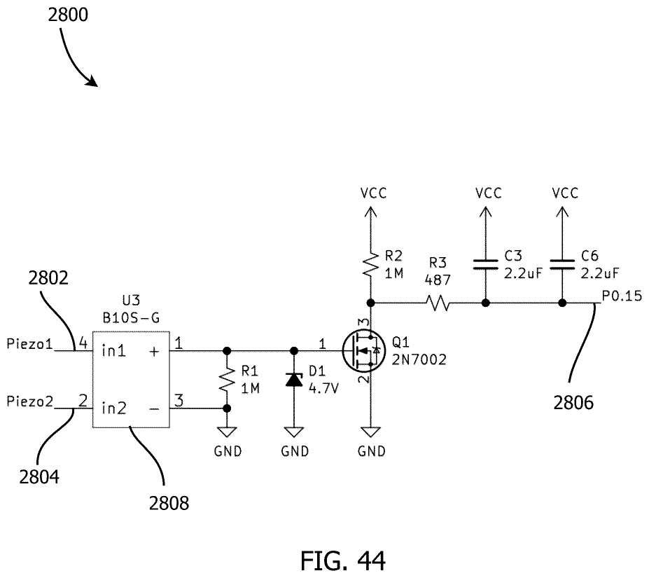

Referring to FIG. 44, there is shown a schematic diagram 2800 of a sensed fluid signal filter that may be used in place of the sensed fluid signal filter represented by the schematic 360 in FIG. 7, in accordance with various embodiments. In various embodiments, the sensed fluid signal may be generated or input as a voltage differential between inputs 2802 and 2804 and the filtered representation of the sensed fluid signal may be output at 2806, which may be in communication with the interface 222 of the I/O interface 212 shown in FIG. 5, for example. In some embodiments, the sensed fluid signal filter may include a bridge rectifier 2808.

In some embodiments, the sensed fluid signal filter represented by the schematic 2800 may have a cut off frequency (at −3 dB gain) of about 74 Hz (corresponding to time constant of 2.14 ms) in response to an input step signal from 0V to 3V. In some embodiments, the sensed fluid signal filter represented by the schematic 2800 may have a cut off frequency (at −3 dB gain) of about 36 mHz (corresponding to time constant of 4.40 s) in response to an input step signal from 3V to 0V.

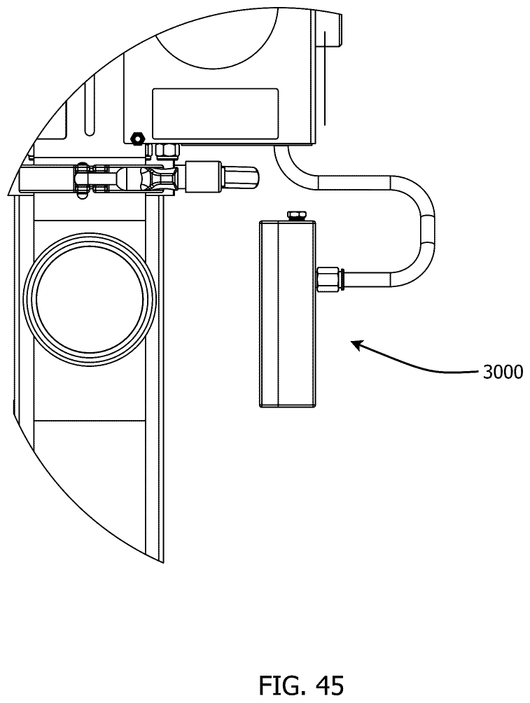

Referring to FIG. 45, there is shown a counter 3000, which may be used in place of the counter 14 shown in FIGS. 3 and 4 or a similar counter, in accordance with various embodiments. In some embodiments, the counter 3000 may function generally similarly to the counter 14 but with a different fluid collector and sensor system. In some embodiments, the counter 3000 may include a generally L-shaped passage instead of the U-shaped passage 126 of the counter 14 shown in FIG. 4.

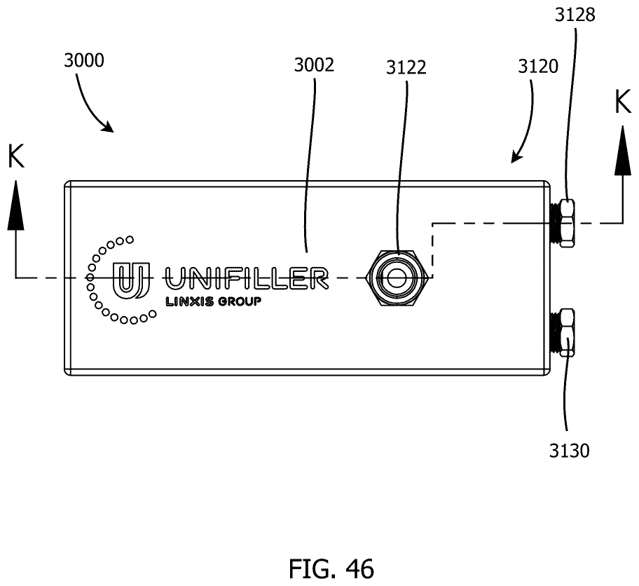

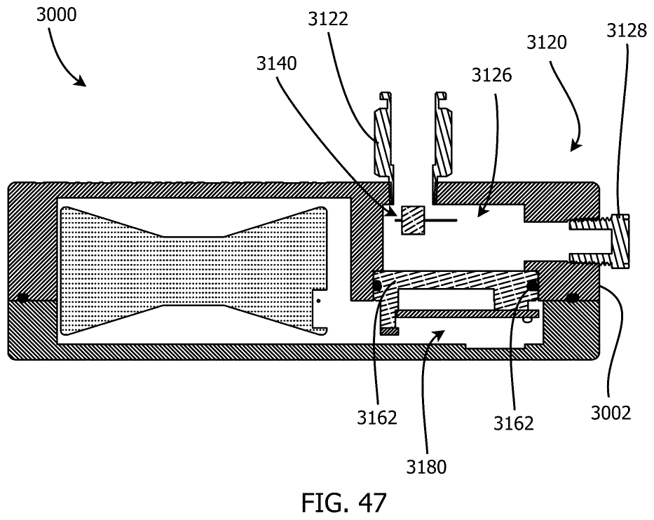

Referring to FIG. 46, a top view of the counter 3000 is shown depicting a cross section 47 upon which a cross sectional view of the counter 3000 shown in FIG. 47 is taken. Referring to FIGS. 46 and 47, the counter 3000 includes a fluid collector 3120 having an inlet 3122 configured to receive fluid flow from a pneumatic device, such as, the pneumatic device 12 shown in FIGS. 1-3.

Referring to FIG. 47, the counter 3000 is shown in cross section along the section 47 shown in FIG. 46 to depict the inner workings of the fluid collector 3120, in accordance with various embodiments. In various embodiments, the inlet 3122 may be coupled to a passage 3126, which may in turn be coupled to outlets 3128 and 3130 (shown in FIG. 46) configured to output the fluid flow. In various embodiments, the fluid collector 3120 may be generally symmetric such that the outlet 3130 shown in FIG. 46 functions generally similarly to the outlet 3128 shown in FIGS. 46 and 47.

In various embodiments, during operation, when a pneumatic device outputs exhaust, the inlet 3122 may receive exhaust fluid or gas from the exhaust port of the pneumatic device and the fluid may flow through the passage 3126 and out of the outlets 3128 and 3130. In various embodiments, the passage 3126 may be generally L-shaped.

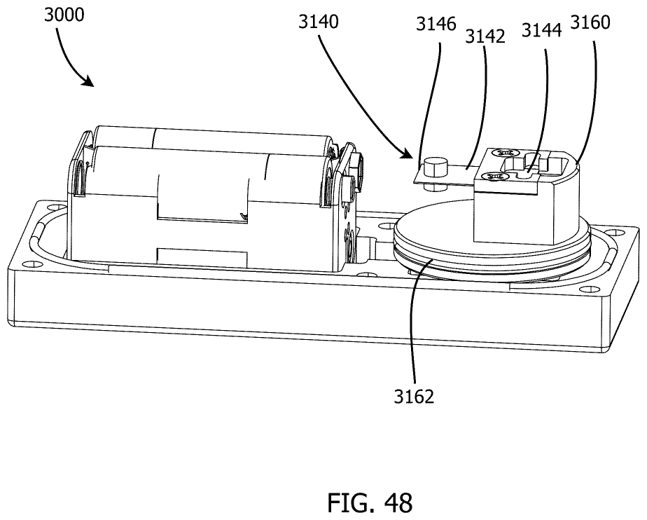

In various embodiments, the counter 3000 may include a sensor 3140 (a portion of which is shown in FIG. 47) configured to sense the fluid flow in the passage 3126 of the fluid collector 3120. Referring to FIG. 48, the counter 3000 is shown with a cover (shown at 3002 in FIGS. 46 and 47) removed, to show the sensor 3140 in further detail.

In various embodiments, the sensor 3140 may include a piezo crystal transducer 3142. In some embodiments, the piezo crystal transducer 3142 may be a flexible laminated piezo crystal transducer. In some embodiments, the sensor 3140 may include a sensor mount 3160 and the piezo crystal transducer 3142 may be held at a first end portion 3144 by the sensor mount 3160, such that a second end portion 3146 of the piezo crystal transducer 3142 opposite the first end portion 3144 is suspended in the passage 3126 shown in FIG. 47. In some embodiments, the piezo crystal transducer 3142 may be held such that it becomes a cantilever. In various embodiments, when exhaust air or fluid flows in the passage 3126 shown in FIG. 47, the fluid may engage and deflect the second end portion 3146, causing the piezo crystal transducer 3142 to produce a signal, which may be processed generally as described herein regarding signals produced by the piezo crystal transducer of the sensor 140 shown in FIG. 4, for example. In various embodiments, using the piezo crystal transducer 3142 in a cantilever configuration as shown in FIG. 48 may facilitate strong signal production by the piezo crystal transducer 3142 and/or may facilitate simple, repeatable, and robust sensing of fluid flow received at the inlet 3122.

Referring to FIG. 48, in some embodiments, the sensor mount 3160 may include a base 3162 configured to isolate the passage 3126 from an electronics compartment 3180 (shown in FIG. 47) of the counter 3000. In some embodiments, the base 3162 may include a generally circular or cylindrical profile including a recess for holding an o-ring 3164 (shown in FIG. 47), to facilitate sealing of the base 3162 to the cover 3002 and isolation of the passage 3126 from the electronics compartment 3180.

While specific embodiments of the disclosure have been described and illustrated, such embodiments should be considered illustrative of the disclosure only and not as limiting the disclosure as construed in accordance with the accompanying claims.

1. A system for monitoring use of a pneumatic device by one or more operators, the system comprising at least one processor configured to:
receive a representation of a sensed fluid signal produced by at least one sensor configured to sense fluid flow associated with the pneumatic device;
identify a cyclical feature of the fluid flow based on the received representation of the sensed fluid signal;
increment a device cycle count for the pneumatic device in response to identifying the cyclical feature;
the at least one processor includes at least one counter processor and at least one analyzer processor, the at least one counter processor configured to:
produce signals for causing a representation of the device cycle count to be transmitted to an analyzer including the at least one analyzer processor, the analyzer being separately powered from the at least one counter processor, wherein the at least one analyzer processor is configured to receive the representation of the device cycle count;
determine a waiting time duration since a most recent cycle performance by the pneumatic device; and
the at least one counter processor configured to compare the waiting time duration since the most recent cycle performance with a threshold time duration to determine whether the waiting time duration is greater than the threshold time duration; and
if the waiting time duration is less than the threshold time duration, produce wireless signals requesting a wireless connection for sending the representation of the device cycle count to the analyzer.

2.-8. (canceled)

9. The system of claim 1 wherein the at least one processor is configured to determine a remaining cycle count, the remaining cycle count being a difference between a milestone cycle count and the device cycle count;
the milestone cycle count includes a predicted end of life cycle count;
the at least one processor is configured to produce signals for causing a representation of the remaining cycle count to be displayed to at least one of the one or more operators;
the at least one processor is configured to receive a pneumatic device identifier identifying the pneumatic device and determine the milestone cycle count based at least in part on the pneumatic device identifier; and
the at least one processor is configured to:
determine a predicted cycling rate, the predicted cycling rate representing a predicted number of cycles that the pneumatic device will be used for during a future time period;
determine a device action date based at least in part on the predicted cycling rate and the remaining cycle count; and
produce signals for causing a representation of the device action date to be displayed to at least one of the one or more operators.

10.-13. (canceled)

14. The system of claim 9 wherein the milestone cycle count includes a suggested service cycle count and the device action date includes a suggested device service date.

15. The system of claim 14 wherein the at least one processor is configured to produce signals for causing a calendar depicting the suggested service date to be displayed.

16. The system of claim 14 wherein the at least one processor is configured to receive a plurality of candidate service dates on which service of the pneumatic device is preferred and wherein the at least one processor is configured to determine an ideal service date based at least in part on the predicted cycling rate and the remaining cycle count and select the suggested service date from the plurality of candidate service dates based at least in part on proximity to the ideal service date.

17. The system of claim 14 wherein the at least one processor is configured to receive a representation of device cycle counts over time and determine the predicted cycling rate based on the device cycle counts over time.

18. (canceled)

19. The system of claim 17 wherein the at least one processor is configured to apply a trend identifying filter to the device cycle counts over time to determine the predicted cycling rate.

20. The system of claim 17 wherein the at least one processor is configured to apply a low pass filter to the device cycle counts over time to determine an average rate of change of the device cycle counts over a past time period and determine the predicted cycling rate to be equal to the determined average rate of change.

21.-22. (canceled)

23. The system of claim 1 wherein the threshold time duration is greater than 5 seconds and less than 120 minutes.

24.-28. (canceled)

29. The system of claim 1 wherein the device cycle count includes a first device cycle count and wherein the at least one processor includes at least one aggregator processor configured to:
determine whether a time elapsed since receiving the representation of the first device cycle count is greater than a threshold time elapsed; and
if the time elapsed is greater than the threshold time elapsed, request a second representation of a second device cycle count for the pneumatic device.

30. (canceled)

31. The system of claim 1 further comprising:
the pneumatic device;
the fluid flow associated with the pneumatic device includes exhaust gas flow from the pneumatic device;
the at least one sensor configured to sense the fluid flow associated with the pneumatic device and to produce the sensed fluid signal;
a fluid collector having an inlet configured to receive the fluid flow from the pneumatic device, a passage coupled to the inlet, and an outlet coupled to the passage and configured to output the fluid flow, wherein the at least one sensor is configured to sense the fluid flow in the passage of the fluid collector.

32.-34. (canceled)

35. The system of claim 31 wherein the fluid collector includes at least one fluid redirecting surface in the passage configured to cause a change in direction of the fluid flow and wherein the at least one sensor is configured to sense forces on the at least one fluid redirecting surface
wherein the at least one fluid redirecting surface is configured to cause at least about a 90 degree change in direction of the fluid flow,
wherein the passage includes an input portion, an output portion, and a sensing portion coupled between the input portion and the output portion, wherein the input and output portions are generally parallel and configured to facilitate movement of the fluid flow in opposite directions, and wherein the sensing portion includes the at least one fluid redirecting surface.

36.-37. (canceled)

38. The system of claim 31 wherein the at least one sensor comprises at least one piezo crystal transducer.

39. The system of claim 38 wherein the at least one sensor includes a sensor mount and the piezo crystal transducer is held at a first end portion by the sensor mount, such that a second end portion of the piezo crystal transducer opposite the first end portion is suspended in the passage.

40. The system of claim 1 wherein the at least one processor is configured to:
receive a partial device cycle count representing a count of cycles performed by the pneumatic device over a counted operating time period;
receive a representation of a duration of an uncounted operating time period;
determine an estimated cycle count over the uncounted time period based at least in part on the partial device cycle count, a duration of the counted operating time period, and the duration of the uncounted operating time period; and
determine the device cycle count based at least in part on the estimated cycle count over the uncounted time period.

41. The system of claim 40 wherein the at least one processor is configured to sum the estimated cycle count over the uncounted time period with the partial device cycle count.

42. The system of claim 40 wherein the partial device cycle count is a first partial device cycle count and the counted operating time period is a first counted operating time period, wherein the at least one processor is configured to receive a second partial device cycle count and sum the estimated cycle count over the uncounted time period with the second partial device cycle count.

43. The system of claim 40 wherein the at least one processor is configured to:
determine an estimated cycling rate during the uncounted operating time period; and
multiply the estimated cycling rate by the duration of the uncounted operating time period.

44. The system of claim 43 wherein the at least one processor is configured to determine a ratio between the partial device cycle count and a duration of the counted operating time period.

45.-135. (canceled)

136. The system of claim 16, wherein the at least one processor is configured to receive a representation of device cycle counts over time and determine the predicted cycling rate based on the device cycle counts over time.
